(19) United States
(12) Patent Application Publication
(10) Pub. No.: US 2023/0117558 A1
(43) Pub. Date: Apr. 20, 2023

(54) INFORMATION PROCESSING APPARATUS

(71) Applicant: TOYOTA JIDOSHA KABUSHIKI KAISHA, Toyota-shi (JP)

(72) Inventors: Yuki KUDO, Kawaguchi-shi (JP); Kazutaka KIMURA, Mishima-shi (JP); Kazuki OBATA, Susono-shi (JP); Hiromitsu KIGURE, Ashigarakami-gun (JP); Satoshi KIKUCHI, Hadano-shi (JP); Yuta MANIWA, Susono-shi (JP)

(73) Assignee: TOYOTA JIDOSHA KABUSHIKI KAISHA, Toyota-shi (JP)

(21) Appl. No.: 17/967,062

(22) Filed: Oct. 17, 2022

(30) Foreign Application Priority Data
Oct. 19, 2021 (JP) 2021-170716

(51) Int. Cl. B60L 53/66; B60L 53/64; B60L 53/62

(52) U.S. Cl. CPC B60L 53/665; B60L 53/62; B60L 53/64

(57) ABSTRACT

An agent is an information processing apparatus that puts in a bid to allow a vehicle to conduct transaction of power reception/provision through a transaction market server. In the event of nonfulfillment of transaction which means that the vehicle does not conduct transaction of power reception/provision, the transaction market server performs penalty processing for imposing a penalty on a user of the vehicle. The agent includes a bid processing unit and an indicator value calculator. The bid processing unit is configured to put in a bid to the transaction market server. The indicator value calculator calculates an indicator value that represents an extent of the penalty imposed on the user in the penalty processing. When the indicator value reaches a threshold value, the bid processing unit suspends a bid.

This nonprovisional application is based on Japanese Patent Application No. 2021-170716 filed with the Japan Patent Office on Oct. 19, 2021, the entire contents of which are hereby incorporated by reference.

### BACKGROUND

### Field

The present disclosure relates to an information processing apparatus and particularly to an information processing apparatus that puts in a bid to allow a vehicle as an electric power resource to conduct transaction of power reception or provision (which is also referred to as “power reception/provision”) through a power transaction market server.

### Description of the Background Art

Japanese Patent Laying-Open No. 2020-150726 discloses a power supply and demand management apparatus. This apparatus includes a first computing unit, a second computing unit, and a controller. The first computing unit calculates a quantity of imbalance that may be caused within unit time of bid. The second computing unit calculates a quantity of control for a power storage and a quantity of control for a load in order to decrease the quantity of imbalance calculated by the first computing unit to zero. The controller transmits these quantities of control to the power storage and the load, respectively. A quantity of charging and discharging to and from the power storage and power consumption in the load are controlled to decrease the quantity of imbalance to zero.

### SUMMARY

With deregulation of electric utilities, introduction of peer to peer (P2P) power transaction in a power transaction market has been considered. In P2P power transaction, individuals and corporates that possess electric power resources directly conduct selling or buying transaction of electric power to and from other individuals and corporates. A vehicle as an electric power resource may conduct transaction of power reception/provision through a power transaction market server. In this case, an information processing apparatus automatically puts in a bid for transaction of power reception/provision to the power transaction market server. The power transaction market server concludes a contract for the bid.

The vehicle may not conduct transaction of power reception/provision as determined in a contract (occurrence of nonfulfillment of transaction). When nonfulfillment of transaction occurs, imbalance is caused. Consequently, a penalty is imposed on a user of the vehicle. Increase of the penalty while the user is unaware thereof is not preferable.

When imbalance is caused in power transaction by the vehicle, the vehicle may be able to decrease a quantity of imbalance to zero by adjusting power consumption in a vehicle-mounted load as described in Japanese Patent Laying-Open No. 2020-150726. Typically, however, it is difficult for the vehicle to decrease the quantity of imbalance to zero as such.

The present disclosure was made to solve the problem above, and an object thereof is to avoid increase of a penalty while a user of a vehicle as an electric power resource is unaware thereof when the vehicle is used in P2P power transaction.

An information processing apparatus according to the present disclosure is an information processing apparatus that puts in a bid to allow a vehicle as an electric power resource to conduct transaction of power reception or provision through a power transaction market server. The power transaction market server is configured to perform contract processing for concluding a contract for the bid for transaction of the power reception or provision. The power transaction market server performs penalty processing for imposing a penalty on a user of the vehicle in the event of nonfulfillment of the transaction which means that the vehicle does not conduct transaction of the power reception or provision in accordance with contract content information indicating contents of the contract. The information processing apparatus includes a bid processing unit and an indicator value calculator. The bid processing unit is configured to put in the bid to the power transaction market server. The indicator value calculator calculates an indicator value that represents an extent of the penalty imposed on the user in the penalty processing. The bid processing unit suspends the bid when the indicator value reaches a threshold value.

With the configuration above, when the indicator value reaches the threshold value, the bid may be withdrawn or a future bid may not be put in. Since the contract is thus not concluded, transaction of power reception/provision is not scheduled. Consequently, occurrence of nonfulfillment of transaction is avoided. Therefore, increase of the penalty while the user of the vehicle is unaware thereof can be avoided.

The indicator value may include the number of times of the penalty.

With the configuration above, penalties repeated for a long period to such an extent that the number of times of penalty exceeds the threshold value can be avoided.

The penalty may include a penalty charge charged to the user. The indicator value may include a cumulative charge of the penalty charge.

With the configuration above, charging to the user of such a heavy cumulative charge as unexpected by the user can be avoided.

The information processing apparatus may include a state obtaining unit, a state history storage, and a state predictor. The state obtaining unit obtains a vehicle state. History of the vehicle state is stored in the state history storage. The state predictor predicts the vehicle state after current time in accordance with the history stored in the state history storage. The bid processing unit puts in the bid in accordance with a result of prediction by the state predictor. The bid processing unit may resume the bid when an evaluation value representing magnitude of a difference between a result of obtainment by the state obtaining unit and a result of prediction by the state predictor becomes smaller than a reference value after the bid is suspended.

When the evaluation value becomes smaller than the reference value after suspension of the bid, it is considered that prediction by the state predictor is appropriately made. Therefore, there may be no problem because the bid has come to appropriately be put in even when the bid is resumed. Therefore, with the configuration above, the bid can appropriately be resumed.

The information processing apparatus may include a state obtaining unit, a state history storage, and a state predictor. The state obtaining unit obtains a vehicle state. History of the vehicle state is stored in the state history storage. The state predictor predicts the vehicle state after current time in accordance with the history stored in the state history storage. The bid processing unit puts in the bid in accordance with a result of prediction by the state predictor. The bid processing unit may resume the bid a prescribed time period after suspension of the bid.

A prescribed time period after suspension of the bid, prediction by the state predictor may appropriately be made. Therefore, there may be no problem because the bid may have come to appropriately be put in even when the bid is resumed. Therefore, with the configuration above, while processing for determination as to resumption of the bid is simplified, the bid can appropriately be resumed.

The information processing apparatus may further include a notification processing unit configured to perform notification processing for giving a notification to the user when the bid is suspended.

With the configuration above, the user can notice suspension of the bid.

The notification processing may include processing for inquiring of the user whether to resume the bid. The bid processing unit may resume the bid when there is a response indicating resumption of the bid.

With the configuration above, the bid can be resumed based on a user’s intention. Consequently, usability can be improved.

The information processing apparatus may further include a penalty history storage, a possibility estimator, and a threshold value setting unit. History showing for each unit period whether the penalty was imposed on the user is stored in the penalty history storage. The possibility estimator estimates for each unit period possibility of imposition of the penalty on the user in accordance with the history stored in the penalty history storage. The threshold value setting unit sets the threshold value to be smaller during a first unit period during which possibility of imposition of the penalty on the user is higher than during a second unit period during which possibility of imposition of the penalty on the user is lower.

Whether or not imposition of the penalty on the user is likely may be different depending on a unit period. Therefore, with the configuration above, the indicator value is more likely to reach the threshold value in the first unit period than in the second unit period. Suspension of the bid is thus more likely in the first unit period than in the second unit period. Consequently, the total penalty imposed on the user by the time of suspension of the bid can be lessened.

The information processing apparatus may further include a nonfulfillment predictor that predicts whether the nonfulfillment occurs. When the nonfulfillment predictor predicts occurrence of the nonfulfillment, the bid processing unit suspends the bid.

With the configuration above, the bid is suspended before occurrence of nonfulfillment. Occurrence of nonfulfillment is thus prevented. Consequently, imposition of the penalty on the user can be prevented.

The nonfulfillment predictor may determine whether the vehicle is able to arrive at a position of a power facility to which the vehicle is scheduled to be connected for transaction of the power reception or provision before scheduled time to start the power reception or provision in accordance with first position information indicating a current position of the vehicle, second position information indicating a position of the power facility, and current time. The nonfulfillment predictor predicts occurrence of the nonfulfillment when the nonfulfillment predictor determines that the vehicle is unable to arrive at the position of the power facility before the scheduled time to start.

With the configuration above, when the vehicle is determined as being unable to arrive at the position of the power facility before scheduled time to start transaction of power reception/provision, the bid is suspended. Imposition of the penalty on the user due to occurrence of nonfulfillment can thus be prevented.

When the nonfulfillment of the transaction occurs, the bid processing unit may put in a bid for selling a right to power reception or provision to and from a transaction partner of the vehicle in the transaction to the power transaction market server. This power is electric power in a quantity determined in the contract in connection with the transaction.

When the contract for this bid is concluded, the transaction partner can provide or receive electric power in a quantity determined in the contract of transaction where nonfulfillment has occurred, to and from a partner different from the vehicle. A detriment to the transaction partner caused by nonfulfillment of transaction by the vehicle is thus lessened. Consequently, the penalty imposed on the user of the vehicle can be lessened.

Another information processing apparatus according to the present disclosure is an information processing apparatus that puts in a bid to allow a vehicle as an electric power resource to conduct transaction of power reception or provision through a power transaction market server. The power transaction market server is configured to perform contract processing for concluding a contract for the bid for transaction of the power reception or provision. The power transaction market server performs penalty processing for imposing a penalty on a user of the vehicle in the event of nonfulfillment of the transaction which means that the vehicle does not conduct transaction of the power reception or provision in accordance with contract content information indicating contents of the contract. The information processing apparatus includes a bid processing unit and a nonfulfillment predictor. The bid processing unit is configured to put in the bid to the power transaction market server. The nonfulfillment predictor predicts whether the nonfulfillment occurs. When the nonfulfillment predictor predicts occurrence of the nonfulfillment, the bid processing unit suspends the bid.

With the configuration above, when occurrence of nonfulfillment is predicted, the bid may be withdrawn or a future bid may not be put in. Since the contract is thus not concluded, transaction of power reception/provision is not scheduled. Consequently, imposition of the penalty on the user due to occurrence of nonfulfillment of transaction can be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing an exemplary configuration of a system for transmitting and distributing electric power for transaction with the use of an information processing apparatus according to a first embodiment.

FIG. 2 is a diagram schematically showing an exemplary P2P power transaction market.

FIG. 3 is a diagram illustrating an exemplary bid in a general transaction market for P2P power transaction.

FIG. 4 is a diagram illustrating an exemplary bid in a direct transaction market for P2P power transaction.

FIG. 5 is a diagram showing an exemplary hardware configuration of an agent and a transaction market server.

FIG. 6 is a diagram showing exemplary resource information.

FIG. 7 is a diagram showing exemplary agent information.

FIG. 8 is a functional block diagram of the agent and the transaction market server according to the first embodiment.

FIG. 9 is a diagram for illustrating details of processing involved with imposition of a penalty.

FIG. 10 is a flowchart showing exemplary processing involved with transaction of power reception/provision in the first embodiment.

FIG. 11 is a diagram showing in detail, exemplary processing (step S185 in FIG. 10) involved with imposition of a penalty.

FIG. 12 is a flowchart showing in detail, processing (step S185 in FIG. 10) involved with imposition of a penalty in a first modification.

FIG. 13 is a flowchart showing in detail, processing (step S185 in FIG. 10) involved with imposition of a penalty in a second modification.

FIG. 14 is a functional block diagram of the agent and the transaction market server in a third modification.

FIG. 15 is a diagram showing exemplary processing performed by the agent for setting a threshold value TH.

FIG. 16 is a functional block diagram of the agent and the transaction market server in a fourth modification.

FIG. 17 is a flowchart showing in detail, processing (step S185 in FIG. 10) involved with imposition of a penalty in the fourth modification.

FIG. 18 is a flowchart showing processing involved with transaction of power reception/provision in a fifth modification.

FIG. 19 is a functional block diagram of the agent and the transaction market server in a second embodiment.

FIG. 20 is a flowchart showing processing involved with transaction of power reception/provision in the second embodiment.

FIG. 21 is a diagram showing in detail, exemplary processing (step S143) for preventing a penalty.

### DESCRIPTION OF THE PREFERRED EMBODIMENTS

An embodiment of the present disclosure will be described below in detail with reference to the drawings. The same or corresponding elements in the drawings have the same reference characters allotted and description thereof will not be repeated.

### First Embodiment

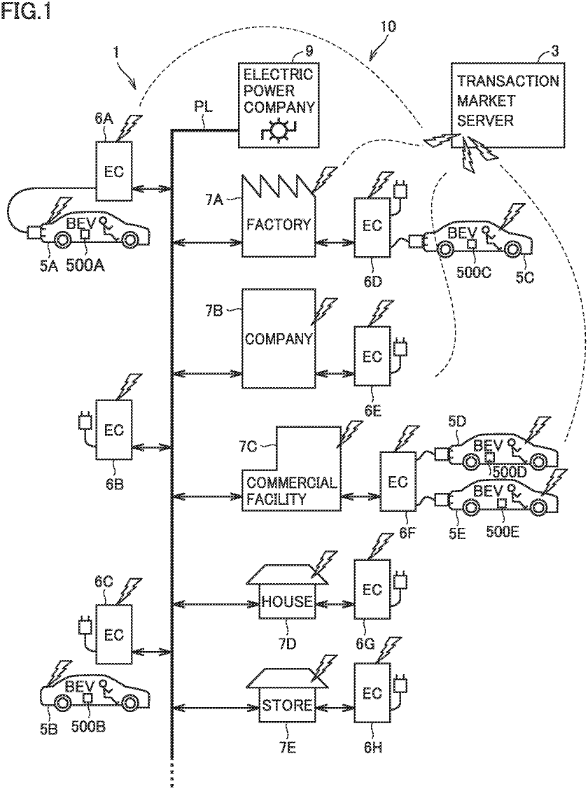

FIG. 1 is a diagram schematically showing an exemplary configuration of a system for transmitting and distributing electric power for transaction with the use of an information processing apparatus according to a first embodiment. Referring to FIG. 1, a power transmission and distribution (T&D) system 1 includes a plurality of electric power resources, charging and discharging facilities 6A to 6H, an electric power company 9, a power transmission line network PL, a transaction market server 3, and a communication network 10.

The plurality of electric power resources include, for example, electrically powered vehicles 5A to 5E, a factory 7A, a company 7B, a commercial facility 7C, a house 7D, and a store 7E. Electrically powered vehicles 5A to 5E include power storages 500A to 500E, respectively. Each electric power resource is configured to provide or receive electric power to and from another electric power resource through power transmission line network PL or directly.

The number of electrically powered vehicles and the number of charging and discharging facilities are not limited as shown. The number of facilities such as factories 7A is not limited as shown either. Electrically powered vehicles 5A to 5E without being distinguished from one another may be referred to as an “electrically powered vehicle 5” below. Power storages 500A to 500E without being distinguished from one another may be referred to as a “power storage 500”. Charging and discharging facilities 6A to 6H without being distinguished from one another may be referred to as a “charging and discharging facility 6”. Factory 7A, company 7B, commercial facility 7C, house 7D, and store 7E without being distinguished from one another may be referred to as a “facility 7”.

Electrically powered vehicle 5 is an electrically powered vehicle that can travel with electric power stored in power storage 500, and it is, for example, a battery electric vehicle (BEV) or a plug-in hybrid electric vehicle (PHEV). Electrically powered vehicle 5 is assumed as a BEV below. Electrically powered vehicle 5 is configured to electrically be connected to charging and discharging facility 6, and can provide or receive electric power to and from power transmission line network PL or facility 7 with charging and discharging facility 6 being interposed.

Facility 7 is electrically connected to power transmission line network PL and can provide or receive electric power to and from power transmission line network PL. Facility 7 is electrically connected also to charging and discharging facility 6 and can provide or receive electric power to and from electrically powered vehicle 5 connected to charging and discharging facility 6.

Charging and discharging facility 6 is electrically connected to power transmission line network PL or facility 7. Charging and discharging facility 6 can electrically be connected to electrically powered vehicle 5 through a power cable, and electrically powered vehicle 5 can provide or receive electric power to and from power transmission line network PL or facility 7 through charging and discharging facility 6 to which it is connected. While charging and discharging facility 6 is connected to electrically powered vehicle 5 through the power cable, a cable connection signal indicating that charging and discharging facility 6 and electrically powered vehicle 5 are connected to each other is transmitted through the power cable.

Electric power generated at a power plant managed by electric power company 9 is supplied to each facility 7 through power transmission line network PL (a system power grid) and may also be supplied to electrically powered vehicle 5A connected to charging and discharging facility 6A. Electric power has conventionally been supplied exclusively from the power plant of electric power company 9 through power transmission line network PL to facility 7 or electrically powered vehicle 5. In this power T&D system 1, power selling and buying transaction, that is, peer to peer (P2P) power transaction, between individuals or corporates (facilities 7 or electrically powered vehicles 5) can be conducted.

Transaction market server 3 provides a platform for conducting such P2P power transaction. Transaction market server 3 is configured to communicate with electrically powered vehicle 5, charging and discharging facility 6, and facility 7 over communication network 10. When facility 7 or electrically powered vehicle 5 desires P2P power transaction, facility 7 or electrically powered vehicle 5 (specifically, an agent that conducts power transaction by facility 7 or electrically powered vehicle 5 (which will be described later)) puts in a bid to transaction market server 3 that manages the P2P power transaction market where power transaction is desired, for example, with a time slot in which selling or buying of electric power is desired, a quantity of electric power sold or bought for each unit time slot, and a transaction price being set as bid conditions. Transaction market server 3 effectuates a contract for power transaction between a seller and a buyer who agree with each other on the bid conditions based on any algorithm, and processes a bid, for which a partner in agreement on the conditions was not found, as an incomplete bid. The “bid” means an action to place an order for power transaction (buy or sell) or the order itself. The “contract” means an action to determine to conduct power transaction for which the bid was put in or the determination itself.

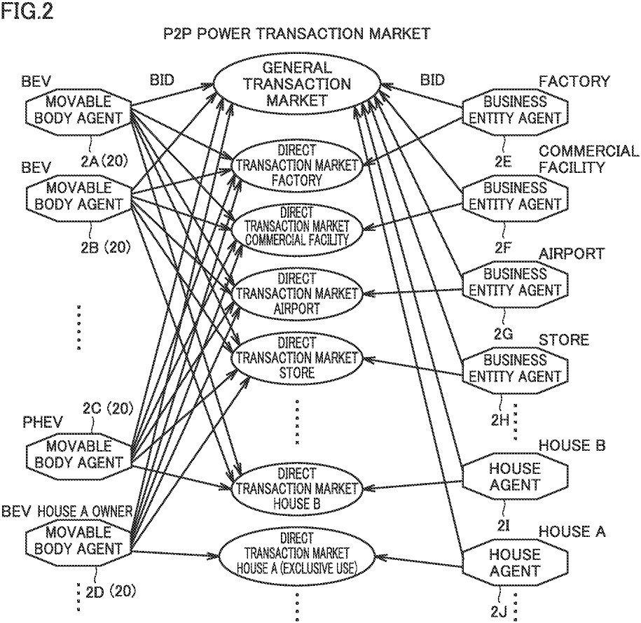

FIG. 2 is a diagram schematically showing an exemplary P2P power transaction market. Referring to FIG. 2, in the P2P power transaction market, an “agent” that puts in a bid to the P2P power transaction market automatically plans a bid and puts in the bid, manages a contract, and creates a charging and discharging plan based on the contract. The agent is provided for each facility 7 or electrically powered vehicle 5. In the present first embodiment, there are a plurality of movable body agents 2A to 2D corresponding to electrically powered vehicles 5, a plurality of business entity agents 2E to 2H corresponding to factory 7A and the like, and a plurality of house agents 2I and 2J corresponding to houses.

For example, description in connection with electrically powered vehicle 5 is representatively given. The movable body agent of electrically powered vehicle 5 creates a power transaction plan (bid plan) for the P2P power transaction market, and the movable body agent puts in a bid to the P2P power transaction market (transaction market server 3).

Movable body agents 2A to 2D, business entity agents 2E to 2H, and house agents 2I and 2J without being distinguished from one another may simply be referred to as an “agent 2” below. Movable body agents 2A to 2D without being distinguished from one another may simply be referred to as an “agent 20”. Agent 20 corresponds to an “information processing apparatus” that creates (sets) a power transaction plan for power transaction by electrically powered vehicle 5 through the P2P power transaction market.

The P2P power transaction market includes a “general transaction market” and a “direct transaction market.” The general transaction market is a market that handles transaction of electric power transmitted over power transmission line network PL, and a large number of unspecified agents 2 can participate in power transaction. In the general transaction market, a contract of power transaction is concluded under any rules determined by an operator that manages the P2P power transaction market (matching). The matching rules include, for example, a method of closing a deal on a first-come first-served basis when a price presented by a seller matches with a price presented by a buyer in a prescribed unit time slot. Other matching rules can include also a method of once organizing bids (orders) from sellers and buyers put in a unit time slot and closing a deal at an appropriate price.

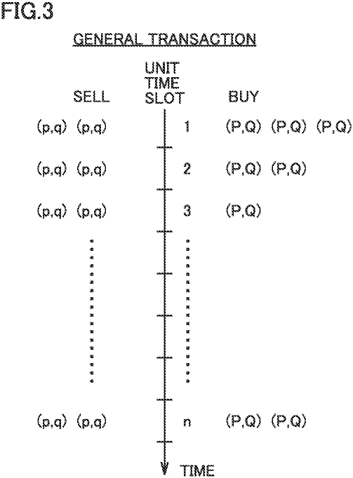

FIG. 3 is a diagram illustrating an exemplary bid in the general transaction market for P2P power transaction. Referring to FIG. 3, in the general transaction market, a large number of unspecified sellers put in bids each expressed as a set (p, q) of a selling price and a quantity of electric power for each prescribed unit time slot (1, 2, ..., and n) while a large number of unspecified buyers put in bids each expressed as a set (P, Q) of a buying price and a quantity of electric power. The unit time slot refers to a time frame (for example, for thirty minutes) set in the general transaction market. Transaction of the quantity of electric power is conducted for each quantity of electric power transmitted in the unit time slot (electric power × duration of unit time slot).

Referring again to FIG. 2, the direct transaction market is a market that handles transaction of electric power transmitted not via power transmission line network PL as a result of movement of electrically powered vehicle 5 to a location of facility 7, and only an agent having an ID for the direct transaction market can participate in power transaction. In the direct transaction market, one market is defined for facility 7 where charging and discharging facility 6 is provided. A server provided for each facility 7 may manage a single direct transaction market, or a server for shared use may manage a plurality of direct transaction markets defined by a plurality of facilities 7. In the direct transaction market, a contract for power transaction is concluded under any rules independently determined by an operator of each market (matching). The method above described in connection with the general transaction market can be adopted as the matching rules.

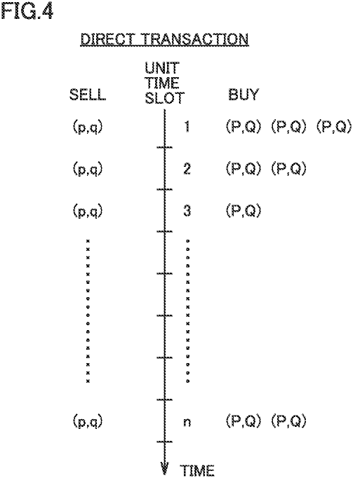

FIG. 4 is a diagram illustrating an exemplary bid in the direct transaction market for P2P power transaction. Referring to FIG. 4, in the direct transaction market, in response to presentation by a seller of a set (p, q) of a selling price and a quantity of electric power for each prescribed unit time slot (1, 2, ..., and n), a plurality of buyers each having an ID for the direct transaction market each put in a bid expressed as a set (P, Q) of a buying price and a quantity of electric power, The unit time slot refers to a time frame individually set in the direct transaction market. Transaction of the quantity of electric power is conducted for each quantity of electric power transmitted in the unit time slot (electric power × duration of unit time slot).

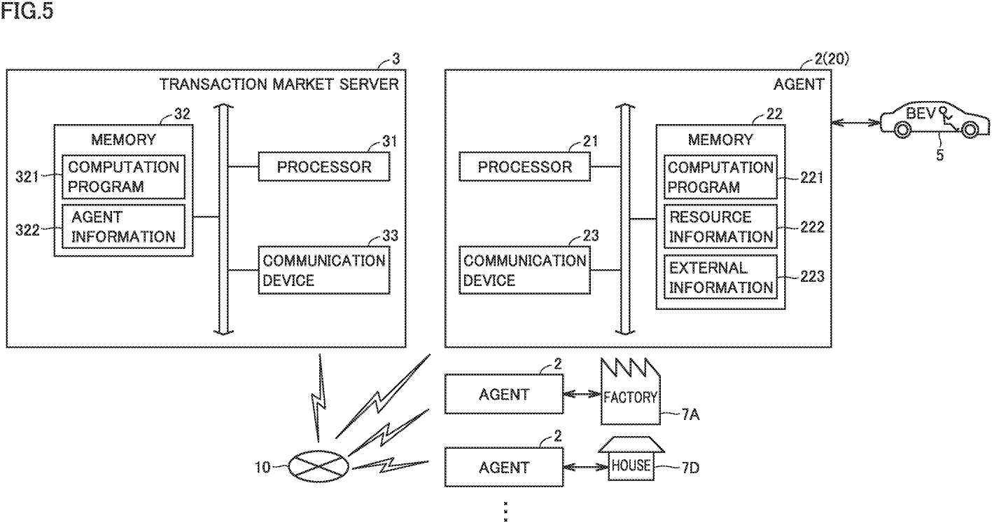

FIG. 5 is a diagram showing an exemplary hardware configuration of agent 2 and transaction market server 3. Referring to FIG. 5, agent 2 includes a processor 21, a memory 22, and a communication device 23. Agent 2 is provided for each electric power resource such as electrically powered vehicle 5 and facility 7 (factory 7A and house 7D). Agent 2 may be provided within a corresponding electric power resource or in a cloud that can communicate with a corresponding electric power resource. Agent 2 is the same in hardware configuration as agent 20 (movable body agent).

Processor 21 is a computation entity (computer) that performs various types of processing by executing various programs. Processor 21 is implemented by a central processing unit (CPU), a field-programmable gate array (FPGA), or a graphics processing unit (GPU). Processor 21 may be implemented by processing circuitry.

A program and data for processor 21 to perform various types of processing are stored in memory 22. Memory 22 is implemented by such a storage medium as a read only memory (ROM) and a random access memory (RAM). A computation program 221, resource information 222, and external information 223 are stored in memory 22.

Computation program 221 specifies processing to be performed by processor 21. For example, computation program 221 includes a program for putting in a bid for power transaction in the P2P power transaction market managed by transaction market server 3 to transaction market server 3.

Resource information 222 includes information on an electric power resource corresponding to agent 2 (for example, electrically powered vehicle 5), and particularly includes information on a bid and a contract for power transaction.

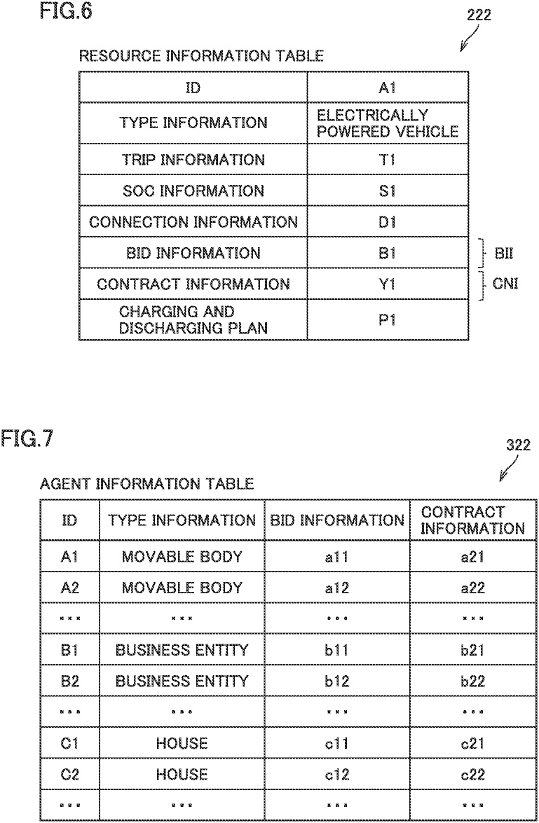

FIG. 6 is a diagram showing exemplary resource information 222. FIG. 6 shows resource information 222 in agent 2 of electrically powered vehicle 5 (movable body agent) by way of example. Though resource information 222 is expressed in a table format in this example, the format is not limited to the table format.

Referring to FIG. 6, resource information 222 includes an ID, type information, trip information, state of charge (SOC) information, connection information, bid information BII, contract information CNI, and a charging and discharging plan.

The ID includes identification information for specifying an electric power resource (electrically powered vehicle 5 in this example). The type information includes information on a type of the electric power resource, and includes, for example, information for specifying an electrically powered vehicle, a business entity, or a house. The trip information includes information on history of travel such as a travel route and a time period for travel in the past. The SOC information includes information on a quantity of electric power currently stored in power storage 500. The connection information includes information for specifying whether or not connection to charging and discharging facility 6 has currently been established. Bid information BII includes information on history of bids in the past (for example, date and time of bids in the past), a bid that has currently been put in, and information on a bid scheduled to be put in after the current time. Contract information CNI includes information on history of contracts in the past, whether or not a bid that has currently been put in has been concluded, and information for specifying contents of a contract (for example, a time slot in which power reception/provision is scheduled and a scheduled quantity of electric power to be received or provided in that time slot) when the bid has been concluded. The charging and discharging plan includes information on a charging and discharging plan for power transaction by an electric power resource, and it is created based on a contract.

The trip information and the connection information are information to be used by agent 2 of electrically powered vehicle 5 (agent 20), and they are blank for facility 7 (factory 7A or house 7D).

Referring again to FIG. 5, external information 223 includes a price of electric power in the grid provided by electric power company 9, meteorological information (a quantity of solar ray radiation, weather, and a wind speed) of an area of the P2P power transaction market where a bid is put in, and information on a renewable energy generation facility (a photovoltaic power generation facility, a wind power generation facility, and a water power generation facility) in the market. Agent 2 obtains such external information 223 from an external server (which may be transaction market server 3) through communication network 10.

Communication device 23 transmits and receives various types of data to and from transaction market server 3 through communication network 10. By way of example, communication device 23 transmits data indicating start and end of power reception/provision at a corresponding electric power resource to transaction market server 3.

Transaction market server 3 includes a processor 31, a memory 32, and a communication device 33. Transaction market server 3 is an apparatus that manages P2P power transaction between electric power resources in the P2P power transaction market (the general transaction market and the direct transaction market) and performs processing involved with power transaction.

Processor 31 is a computation entity (computer) that performs various types of processing by executing various programs. Processor 31 is implemented by a CPU, an FPGA, or a GPU. Processor 31 may be implemented by processing circuitry.

A program and data for processor 31 to perform various types of processing are stored in memory 32. Memory 32 is implemented by such a storage medium as a ROM and a RAM. A computation program 321 and agent information 322 are stored in memory 32.

Computation program 321 specifies processing to be performed by processor 31. For example, computation program 321 includes a program for performing bid reception processing for receiving bids from a plurality of agents 2 and contract processing based on the bids. The contract processing refers to processing for concluding a contract for a bid for transaction of power reception/provision. More specifically, contract processing refers to processing for concluding a contract for power transaction between a seller and a buyer who agree with each other on a bid condition and for processing a bid, for which a partner in agreement on the condition was not found, as an incomplete bid.

Agent information 322 includes information on agent 2 that participates in the P2P power transaction market managed by transaction market server 3, and particularly includes information on a bid and a contract for power transaction for each agent 2.

FIG. 7 is a diagram showing exemplary agent information 322. Though agent information 322 is expressed in a table format in this example, the format is not limited to the table format.

Referring to FIG. 7, agent information 322 includes an ID, type information, bid information, and contract information.

The ID specifies agent 2 that participates in the P2P power transaction market managed by transaction market server 3. The type information includes information on the type of an electric power resource and includes, for example, information for specifying an electrically powered vehicle, a business entity, or a house.

The bid information includes information on history of bids in the past in each agent 2 and information on a bid that has currently been put in. The bid information in agent information 322 is associated with bid information BII in resource information 222 (FIG. 6) of an electric power resource with a corresponding ID.

The contract information includes information on history of contracts in the past in each agent 2, whether or not a bid that has currently been put in has been concluded, and information for specifying contents of a contract (for example, a time slot in which power reception/provision is scheduled and a scheduled quantity of electric power to be received or provided in that time slot) when the bid has been concluded. The contract information in agent information 322 is associated with contract information CNI in resource information 222 (FIG. 6) of an electric power resource with a corresponding ID.

When nonfulfillment of power transaction occurs, the electric power company is required to compensate for nonfulfillment (for example, to supply electric power for compensating for shortage of electric power or to buy excessively supplied electric power). Nonfulfillment of power transaction refers to failure in power reception/provision by electrically powered vehicle 5 in accordance with contract content information indicating contents of the contract (that is, as in contents of the contract). When nonfulfillment occurs, transaction market server 3 performs penalty processing. The penalty processing refers to processing for imposing a penalty on electrically powered vehicle 5 (more specifically, a user of electrically powered vehicle 5). By way of example, when power reception/provision by electrically powered vehicle 5 does not start in spite of coming of scheduled time to start power reception/provision determined in the contract, transaction market server 3 determines that nonfulfillment of power transaction has occurred and performs penalty processing.

Referring again to FIG. 5, communication device 33 transmits and receives various types of data to and from agent 2 through communication network 10.

In the P2P power transaction market composed of agent 2 and transaction market server 3 as such, agent 2 makes prediction of use of a corresponding electric power resource (in the case of electrically powered vehicle 5, prediction of use of electrically powered vehicle 5 by the user) and predicts a price for power transaction in the power transaction market in a time slot in which the agent can participate in power transaction. Then, agent 2 creates a power transaction plan (bid plan) optimal in terms of cost under the restriction imposed by SOC upper and lower limits (a range of SOCs within which the power storage can be charged and can discharge) to be fulfilled in a power storage of the corresponding electric power resource, and puts in a bid for power transaction to transaction market server 3.

An example in which electrically powered vehicle 5 is used in P2P power transaction as the electric power resource will representatively be described below. Therefore, a movable body agent (agent 20) is employed as agent 2.

Electrically powered vehicle 5 may fail to conduct transaction of power reception/provision as determined in the contract (occurrence of nonfulfillment of transaction). In the event of nonfulfillment of transaction, imbalance (a difference between a quantity of actually received or provided electric power and a quantity of electric power determined in the contract as a scheduled quantity of electric power to be received or provided) is caused. Consequently, a penalty is imposed on the user of electrically powered vehicle 5. Increase of the penalty while the user is unaware thereof is not preferable.

Agent 20 according to the present first embodiment is provided with a feature for addressing the problem above. Specifically, agent 20 calculates an indicator value that expresses an extent of a penalty imposed on the user in penalty processing. In the present embodiment, the indicator value is expressed by the number of times of penalty. Then, when the indicator value reaches a threshold value, agent 20 suspends a bid. “Suspension of the bid” in the present disclosure encompasses “withdrawing” a bid that has already been put in and “stopping” a future bid (which will be described later in detail).

With the configuration above, when the indicator value reaches the threshold value, the bid may be withdrawn or a future bid may not be put in. Since the contract is thus not concluded, transaction of power reception/provision is not scheduled. Consequently, occurrence of nonfulfillment of transaction is avoided. Therefore, increase of the penalty while the user of the vehicle is unaware thereof (for example, while the user sleeps at night) can be avoided. A functional configuration of agent 20 will be described below in detail.

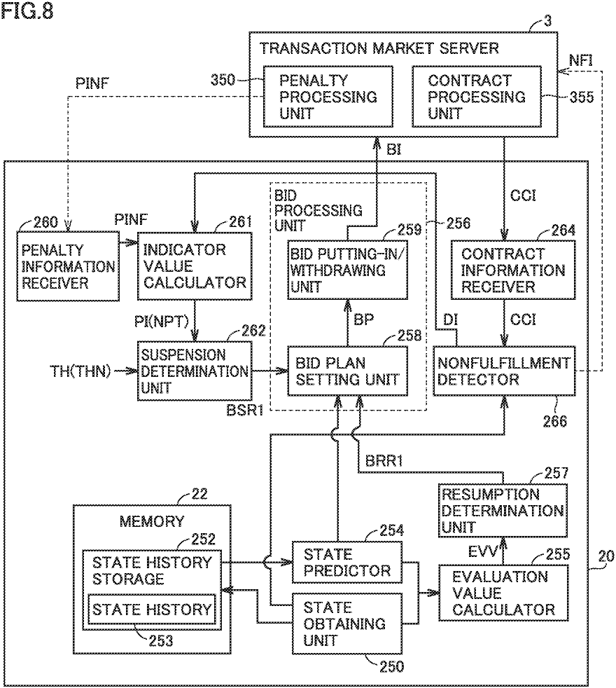

FIG. 8 is a functional block diagram of agent 20 and transaction market server 3 according to the first embodiment. Referring to FIG. 8, agent 20 includes a state obtaining unit 250, a state history storage 252, a state predictor 254, and a bid processing unit 256.

State history storage 252 corresponds to a storage area in memory 22. Functions of state obtaining unit 250, state predictor 254, and bid processing unit 256 are performed by execution of computation program 221 by processor 21 of agent 20.

State obtaining unit 250 obtains a state of electrically powered vehicle 5. By way of example, state obtaining unit 250 calculates an SOC of power storage 500 and obtains a result of calculation as a vehicle state. State obtaining unit 250 may determine whether or not electrically powered vehicle 5 has been connected to charging and discharging facility 6, based on whether or not it receives the cable connection signal described previously through the power cable of charging and discharging facility 6. State obtaining unit 250 has information indicating the vehicle state (in this example, the SOC or whether or not electrically powered vehicle 5 has been connected to charging and discharging facility 6) successively stored in state history storage 252 as a state history 253. Furthermore, the information indicating the vehicle state is provided to a nonfulfillment detector 266 (which will be described later).

State predictor 254 predicts the vehicle state after current time in accordance with state history 253. A result of prediction by state predictor 254 is used by bid processing unit 256.

Bid processing unit 256 is configured to put in a bid to transaction market server 3. Bid processing unit 256 includes a bid plan setting unit 258 and a bid putting-in/withdrawing unit 259.

Bid plan setting unit 258 sets (creates or updates) a bid plan BP in accordance with a result of prediction by state predictor 254. Bid putting-in/withdrawing unit 259 is configured to put in a bid BI to transaction market server 3 in accordance with bid plan BP. Bid BI can thus appropriately be put in in accordance with the result of prediction of the vehicle state after current time. When bid plan BP is set to withdraw the bid, bid putting-in/withdrawing unit 259 can also withdraw the bid.

When an indicator value PI reaches a threshold value (both of which will be described later), bid processing unit 256 suspends bid BI. More specifically, bid plan setting unit 258 sets bid plan BP to suspend bid BI put in by bid putting-in/withdrawing unit 259.

Transaction market server 3 includes a penalty processing unit 350 and a contract processing unit 355. Penalty processing unit 350 performs penalty processing for imposing a penalty on a user of electrically powered vehicle 5 in the event of nonfulfillment of power transaction. Specifically, penalty processing unit 350 generates penalty information PINF indicating contents of a penalty and transmits this information to agent 20. The contents of the penalty include, for example, a penalty charge charged to the user as the penalty.

Contract processing unit 355 performs contract processing for concluding a contract for bid BI and generates contract content information CCI indicating contents of the contract. The contents of the contract include a time slot in which power reception/provision is scheduled (more specifically, time to start power reception/provision and time to quit power reception/provision) and a scheduled quantity of electric power to be received or provided in the time slot. Contract content information CCI is transmitted from transaction market server 3 to agent 20.

Agent 20 further includes a contract content information receiver 264 and nonfulfillment detector 266.

A function of contract content information receiver 264 is performed by communication device 23 of agent 20. A function of nonfulfillment detector 266 is performed by execution of computation program 221 by processor 21 of agent 20.

Contract content information receiver 264 receives contract content information CCI from transaction market server 3. Contract content information CCI is used by nonfulfillment detector 266.

Nonfulfillment detector 266 detects occurrence of nonfulfillment of transaction of power reception/provision in accordance with contract content information CCI and the vehicle state obtained by state obtaining unit 250 (for example, the SOC of power storage 500 or whether or not electrically powered vehicle 5 has been connected to charging and discharging facility 6). By way of example, when electrically powered vehicle 5 does not start power reception/provision in spite of coming of scheduled time to start power reception/provision (for example, when the SOC does not vary or when electrically powered vehicle 5 is not connected to charging and discharging facility 6), nonfulfillment detector 266 detects occurrence of nonfulfillment of power transaction. Nonfulfillment detector 266 may detect occurrence of nonfulfillment by receiving information indicating that electrically powered vehicle 5 is not connected to charging and discharging facility 6 from a control device (not shown) of charging and discharging facility 6 through wired or wireless communication.

Nonfulfillment information NFI indicating contents of nonfulfillment is transmitted from agent 20 to transaction market server 3. Contents of nonfulfillment include the fact that nonfulfillment has occurred, a time slot in which nonfulfillment has occurred, and a quantity of electric power not received or provided due to nonfulfillment (that is, a quantity of imbalance). Nonfulfillment may frequently occur, for example, when prediction by state predictor 254 is inappropriate (unmatch with an actual behavior by a user). Nonfulfillment information NFI is used by penalty processing unit 350 for creation of penalty information PINF.

Nonfulfillment detector 266 outputs detection information DI indicating that nonfulfillment has been detected to an indicator value calculator 261 (which will be described later). Detection information DI further includes information indicating the number of times of consecutive occurrences of nonfulfillment for a concluded contract. For example, when nonfulfillment occurs consecutively n times (n being a natural number), detection information DI is sequentially outputted for each nonfulfillment. In this case, detection information DI outputted in an mth place (m being a natural number: m < n) indicates that nonfulfillment has already occurred consecutively m times when nonfulfillment associated with that detection information DI occurs.

Agent 20 further includes a penalty information receiver 260, indicator value calculator 261, and a suspension determination unit 262.

A function of penalty information receiver 260 is performed by communication device 23 (FIG. 5) of agent 20. Functions of indicator value calculator 261 and suspension determination unit 262 are performed by execution of computation program 221 by processor 21 of agent 20.

Penalty information receiver 260 receives penalty information PINF from transaction market server 3.

Indicator value calculator 261 calculates indicator value PI (in this example, the number of times of penalty NPT) based on penalty information PINF. The number of times of penalty NPT refers, for example, to the cumulative number of times of penalty imposed on a user over a prescribed period (for example, a period of one week). Each time penalty information receiver 260 receives penalty information PINF in this prescribed period, indicator value calculator 261 increments the number of times of penalty NPT by 1. The number of times of penalty NPT may be reset when a prescribed period elapses.

The number of times of penalty NPT may be the number of times of consecutive impositions of the penalty in connection with a contract concluded for bid BI. Indicator value calculator 261 obtains the number of times of consecutive impositions of the penalty based on detection information DI.

Suspension determination unit 262 determines whether or not indicator value PI has reached threshold value TH. In this example, threshold value TH corresponds to the threshold number of times THN and it is set to a prescribed value. When indicator value PI reaches threshold value TH, suspension determination unit 262 outputs a request to bid processing unit 256 to suspend bid BI. This request is also referred to as a bid suspension request BSR1.

When bid plan setting unit 258 of bid processing unit 256 receives bid suspension request BSR1, it updates bid plan BP to suspend bid BI put in by bid putting-in/withdrawing unit 259. Suspension of bid BI will be described below in detail.

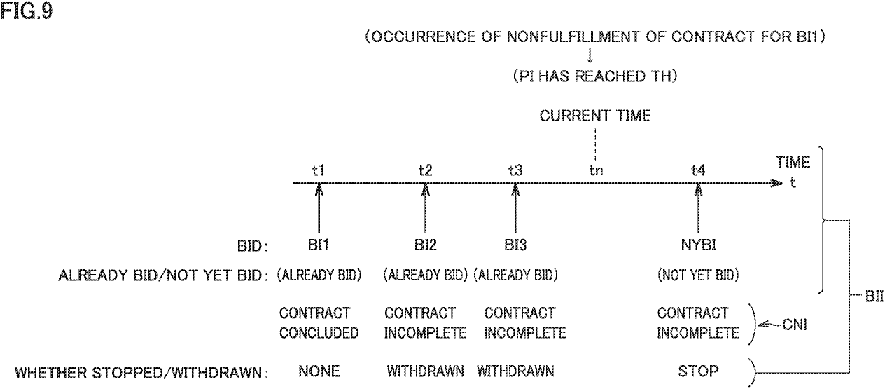

FIG. 9 is a diagram for illustrating details of processing involved with imposition of a penalty. FIG. 8 is referred to as appropriate in the description below.

Referring to FIG. 9, in this example, it is assumed that bid putting-in/withdrawing unit 259 put in bids BI1, BI2, and BI3 at time t1, time t2, and time t3 before current time tn, respectively. Bids BI1, BI2, and BI3 are each exemplary bid BI (FIG. 8). A contract for bid BI1 has already been concluded. A contract for each of bids BI2 and BI3 has not yet been concluded.

It is assumed that, immediately before current time tn, bid putting-in/withdrawing unit 259 is scheduled to put in a bid NYBI at time t4 (after current time tn). More specifically, it is assumed that bid plan BP has been created such that bid putting-in/withdrawing unit 259 is scheduled to put in bid NYBI. At current time tn, bid NYBI has not yet been put in. Therefore, a contract for bid NYBI has not yet been concluded.

Information indicating whether or not each of bids BI1, BI2, and BI3 as well as bid NYBI has been concluded is stored in resource information 222 (FIG. 6) as bid information BII. Information indicating whether or not a contract has been concluded for each of these bids is stored as contract information CNI in resource information 222 (FIG. 6).

At current time tn, nonfulfillment detector 266 detects occurrence of nonfulfillment of power transaction determined in the contract concluded for bid BI1. Then, indicator value calculator 261 calculates (updates) indicator value PI in accordance with penalty information PINF and suspension determination unit 262 makes determination.

In this example, suspension determination unit 262 outputs bid suspension request BSR1 because indicator value PI reaches threshold value TH due to detection of occurrence of nonfulfillment,. When bid processing unit 256 receives bid suspension request BSR1, it suspends bids BI2 and BI3 as well as NYBI. Specifically, bid plan setting unit 258 of bid processing unit 256 updates bid plan BP to withdraw bids BI2 and BI3 and to stop bid NYBI. Bid putting-in/withdrawing unit 259 thus withdraws bids BI2 and BI3 and stops bid NYBI.

Referring again to FIG. 8, agent 20 further includes an evaluation value calculator 255 and a resumption determination unit 257. Functions of evaluation value calculator 255 and resumption determination unit 257 are performed by execution of computation program 221 by processor 21 of agent 20.

Evaluation value calculator 255 calculates an evaluation value EVV indicating magnitude of a difference between a result of obtainment by state obtaining unit 250 and a result of prediction by state predictor 254. Specifically, evaluation value calculator 255 calculates evaluation value EVV in accordance with a result of comparison between an actual current vehicle state and a vehicle state predicted in the past as a current vehicle state. By way of example, evaluation value EVV is expressed as a time difference between a time slot during which electrically powered vehicle 5 was actually connected to charging and discharging facility 6 in a prescribed period before current time and a time slot during which electrically powered vehicle 5 was predicted in the past to be connected to charging and discharging facility 6 in the prescribed period.

Resumption determination unit 257 determines whether or not evaluation value EVV is equal to or larger than a reference value. The reference value is determined in advance as appropriate.

When evaluation value EVV becomes smaller than the reference value after bid BI was suspended, resumption determination unit 257 determines that a bid resumption condition has been satisfied and outputs a bid resumption request BRR1 to bid processing unit 256.

When bid plan setting unit 258 of bid processing unit 256 receives bid resumption request BRR1 while bid BI is under suspension, it updates bid plan BP to resume bid BI. Bid BI put in by bid putting-in/withdrawing unit 259 is thus resumed.

Bid BI is put in in accordance with a result of prediction by state predictor 254. When evaluation value EVV becomes smaller than the reference value, it is assumed that prediction by state predictor 254 is appropriately made (match with an actual behavior by the user). Therefore, there may be no problem because bid BI has come to appropriately be put in even when it is resumed. Therefore, when bid plan BP is updated as above, bid BI can be resumed at appropriate timing. Consequently, the user of agent 20 (the user of electrically powered vehicle 5) can appropriately conduct transaction of power reception/provision again.

When evaluation value EVV is equal to or larger than the reference value after bid BI was suspended, resumption determination unit 257 does not issue bid resumption request BRR1 to bid processing unit 256. Bid BI is thus kept stopped. Therefore, resumption of bid BI while prediction by state predictor 254 is inappropriately made is avoided. Consequently, imposition of a penalty due to nonfulfillment caused by inappropriate bid BI can be avoided.

Even during a period of suspension of bid BI, state predictor 254 continues prediction of the vehicle state. Similarly, bid plan setting unit 258 continues setting (update) of bid plan BP in accordance with a result of prediction by state predictor 254 during this period. The vehicle state during this period is thus reflected on bid plan BP. Consequently, bid BI at the time of resumption can more appropriately be put in (specifically, under a more appropriate bid condition) than in an example where prediction is interrupted during a period of suspension of bid BI.

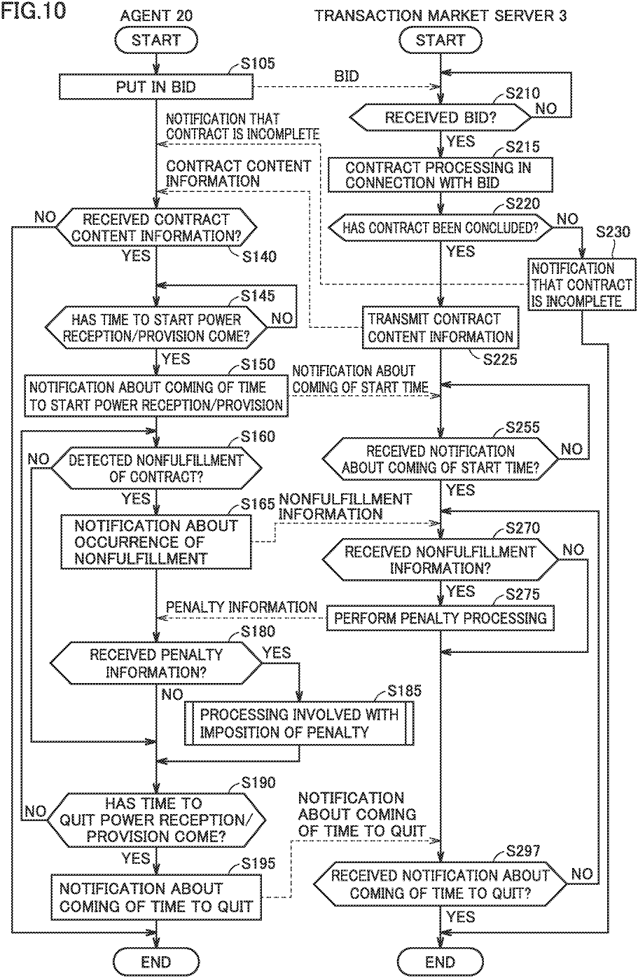

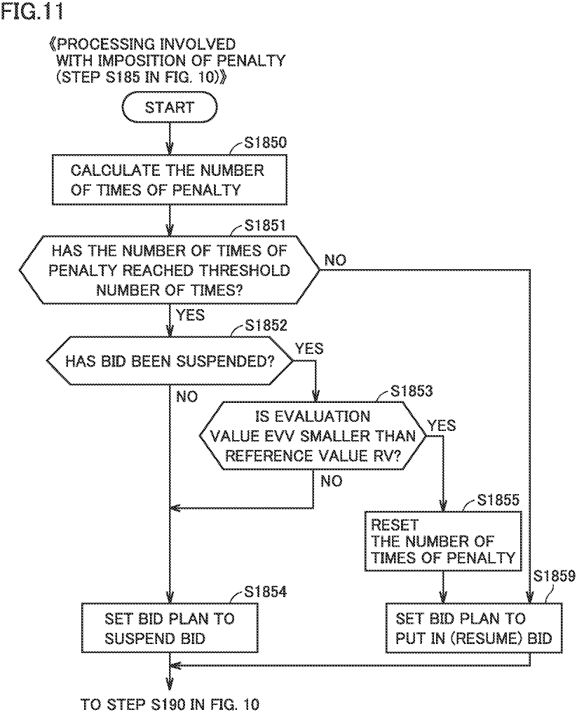

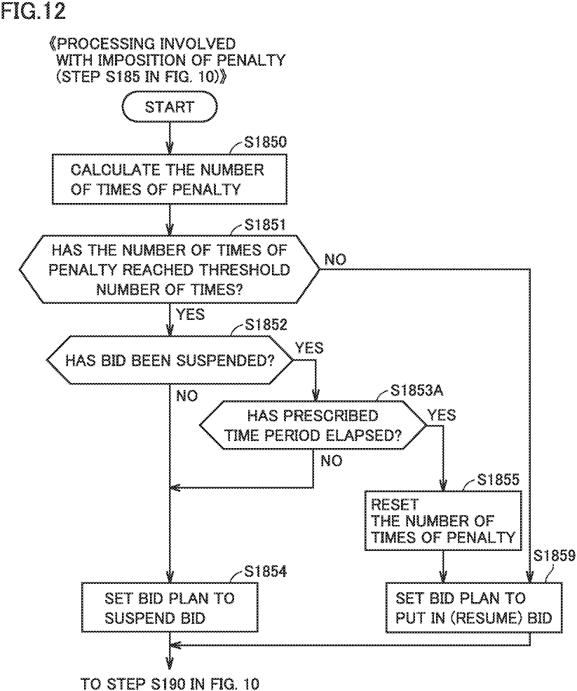

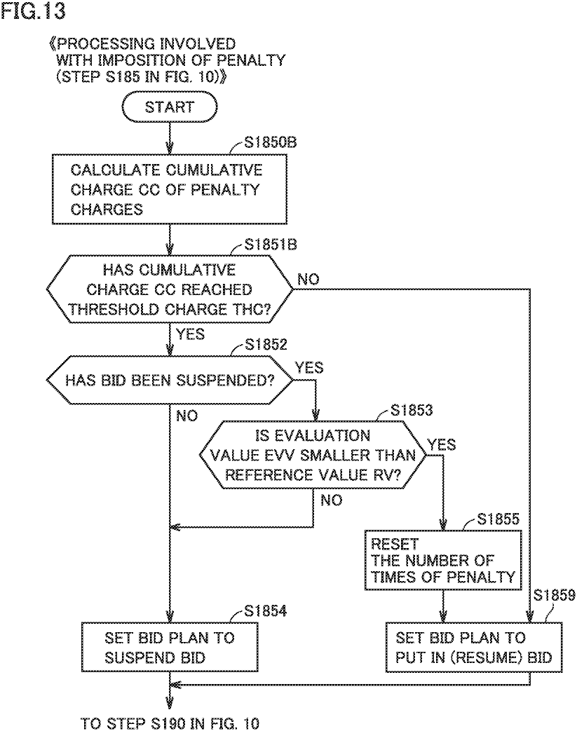

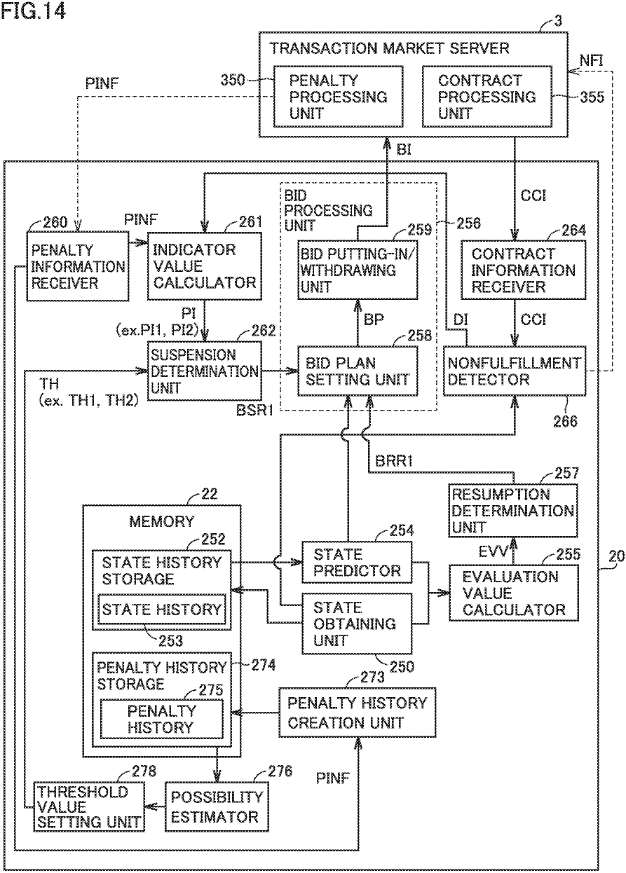

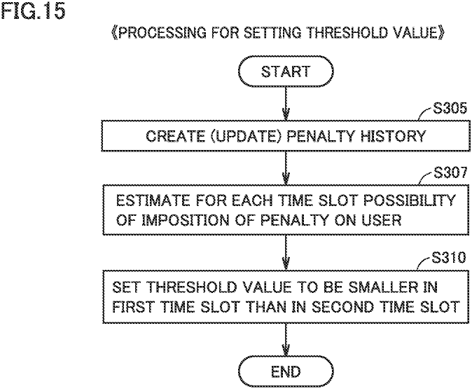

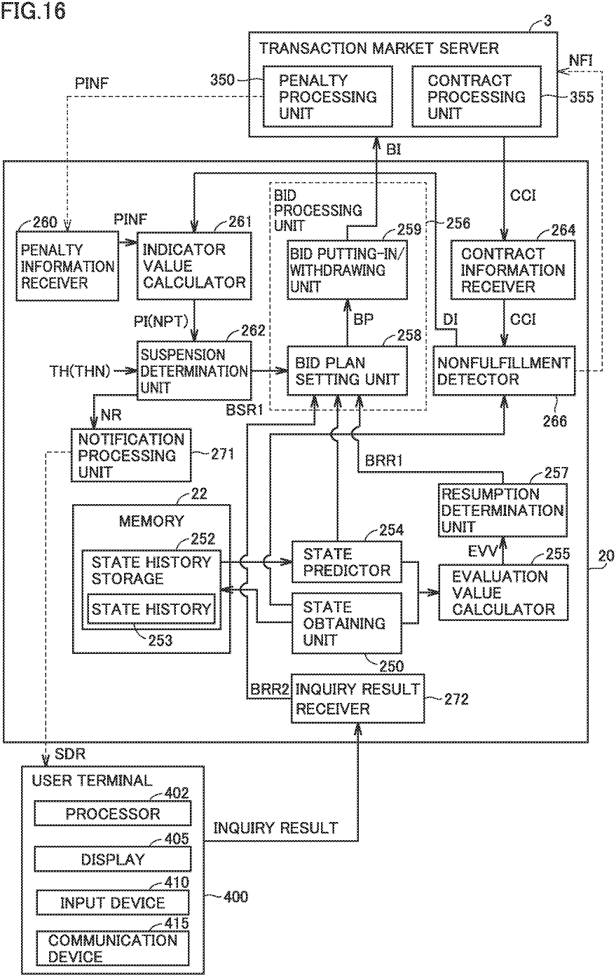

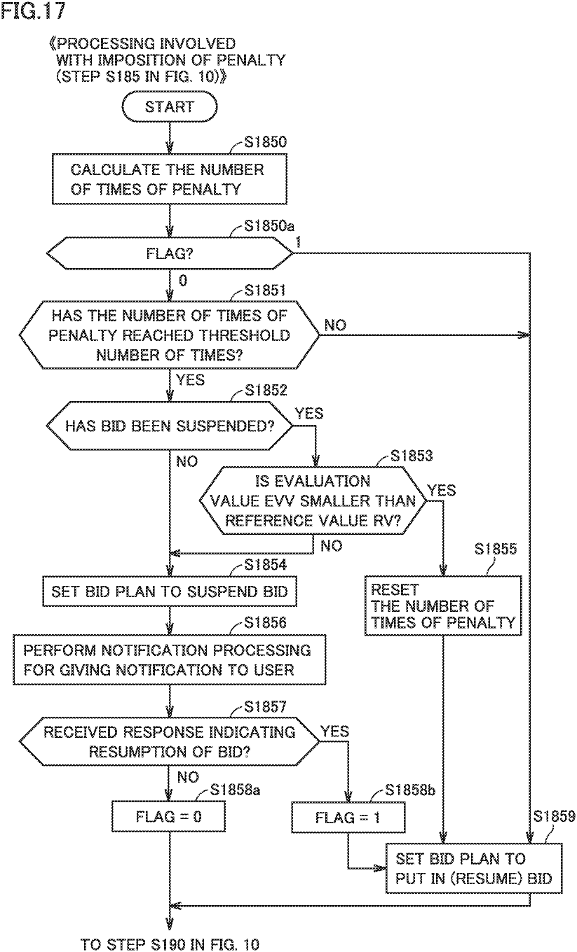

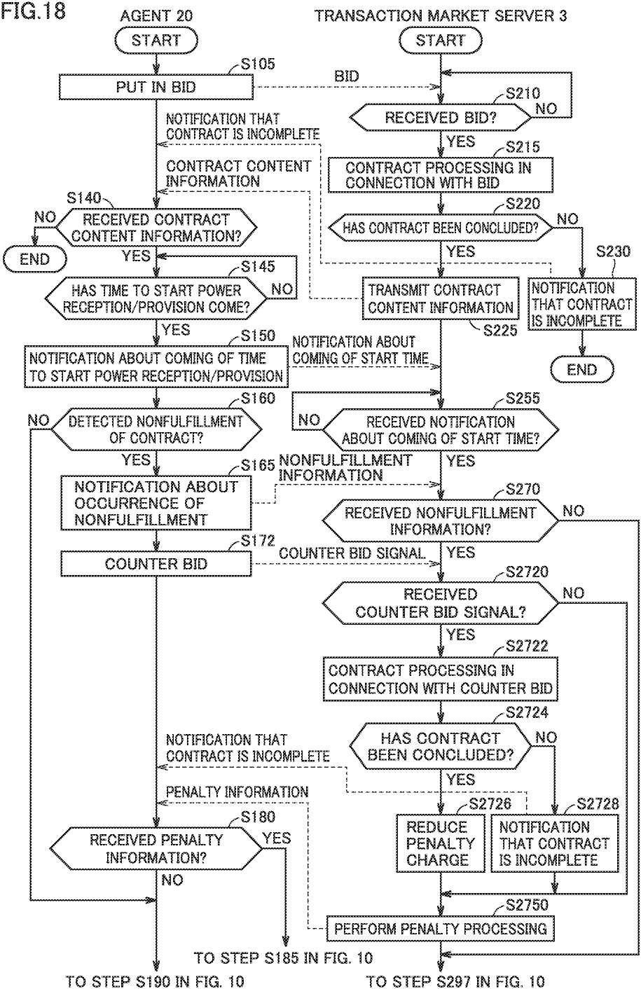

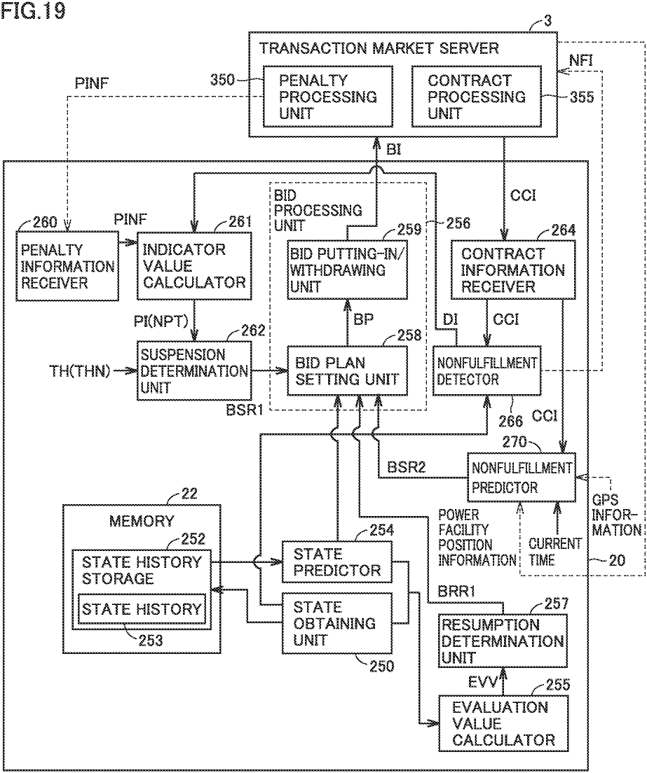

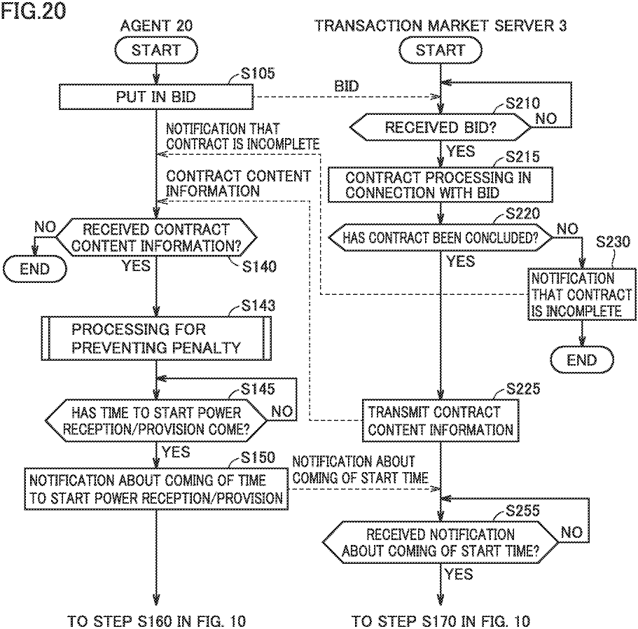

FIG. 10 is a flowchart showing exemplary processing involved with transaction of power reception/provision in the first embodiment. Referring to FIG. 10, agent 20 (processor 21) puts in bid BI to transaction market server 3 (step S105). Bid BI is transmitted from agent 20 to transaction market server 3.

Transaction market server 3 (processor 31) determines whether or not it has received bid BI (step S210). When transaction market server 3 has not received bid BI (NO in step S210), it performs this determination processing until it receives bid BI. When transaction market server 3 has received bid BI (YES in step S210), it performs contract processing for that bid BI (step S215).

Then, transaction market server 3 determines whether or not a contract has been concluded (closed) as a result of the contract processing (step S220). When the contract has not been concluded (NO in step S220), transaction market server 3 notifies agent 20 of the incomplete contract (step S230) and quits the process. When the contract has been concluded (YES in step S220), transaction market server 3 transmits contract content information CCI to agent 20 (step S225).

Agent 20 branches processing in accordance with whether or not it has received contract content information CCI (step S140). When agent 20 has not received contract content information CCI, that is, when it has received a notification that the contract is incomplete (NO in step S140), the process ends. When agent 20 has received contract content information CCI (YES in step S140), the process proceeds to step S145.

Agent 20 determines whether or not time to start power reception/provision (scheduled start time) has come based on contract content information CCI (step S145). When start time has not yet come (NO in step S145), agent 20 performs this determination processing until this time comes. When the start time has come (YES in step S145), agent 20 notifies transaction market server 3 of coming of the time to start power reception/provision (step S150). Thereafter, the process proceeds to step S160.

Transaction market server 3 determines whether or not it has received a notification about coming of the time to start power reception/provision (step S255). When transaction market server 3 has not received this notification (NO in step S255), it performs this determination processing until it receives this notification. When transaction market server 3 has received this notification (YES in step S255), the process proceeds to step S270.

Agent 20 determines whether or not it has detected nonfulfillment of the contract after the time to start power reception/provision (step S160). When agent 20 does not detect nonfulfillment of the contract (NO in step S160), the process proceeds to step S190. When agent 20 detects nonfulfillment of the contract (YES in step S160), it notifies transaction market server 3 of occurrence of nonfulfillment (step S165). Specifically, agent 20 transmits nonfulfillment information NFI to transaction market server 3. Thereafter, the process proceeds to step S180.

Transaction market server 3 determines whether or not it has received nonfulfillment information NFI (step S270). When transaction market server 3 does not receive nonfulfillment information NFI (NO in step S270), the process proceeds to step S297. When transaction market server 3 has received nonfulfillment information NFI (YES in step S270), it generates penalty information PINF and performs penalty processing (step S275). Penalty information PINF is transmitted from transaction market server 3 to agent 20.

Agent 20 determines whether or not it has received penalty information PINF from transaction market server 3 (step S180). When agent 20 does not receive penalty information PINF (NO in step S180), the process proceeds to step S190. When agent 20 has received penalty information PINF (YES in step S180), the process proceeds to step S185. In this case, a penalty is imposed on the user of agent 20 (the user of electrically powered vehicle 5).

Then, agent 20 performs processing involved with imposition of the penalty (step S185). Details of this processing will be described later.

Then, agent 20 determines whether or not time to quit power reception/provision has come (step S190). When the time to quit power reception/provision has not yet come (NO in step S190), agent 20 has the process return to step S160. When the time to quit power reception/provision has come (YES in step S190), agent 20 notifies transaction market server 3 of coming of the time to quit power reception/provision (step S195) and quits the process.

Transaction market server 3 determines whether or not it has received the notification about coming of the time to quit power reception/provision from agent 20 (step S297). When transaction market server 3 has not received this notification (NO in step S297), the process returns to step S270. When transaction market server 3 has received this notification (YES in step S297), the process ends.

FIG. 11 is a diagram showing in detail, exemplary processing (step S185 in FIG. 10) involved with imposition of the penalty.

Referring to FIG. 11, agent 20 calculates the number of times of penalty NPT as indicator value PI (step S1850).

Then, agent 20 determines whether or not the number of times of penalty NPT has reached the threshold number of times THN (step S1851). When the number of times of penalty NPT has not reached the threshold number of times THN (NO in step S1851), agent 20 has the process proceed to step S1859. When the number of times of penalty NPT has reached the threshold number of times THN (YES in step S1851), agent 20 has the process proceed to step S1852.

Then, agent 20 determines whether or not bid BI has been suspended (step S1852). When bid BI has not been suspended (NO in step S1852), agent 20 sets bid plan BP to suspend bid BI (step S1854). More specifically, agent 20 updates bid plan BP to withdraw and stop bid BI (FIG. 9). After processing in step S1854, the process proceeds to step S190 (FIG. 10).

When bid BI has been suspended (YES in step S1852), agent 20 has the process proceed to step S1853. A case of branch of processing to YES in step S1852 corresponds to a case where the process proceeds to step S190 (FIG. 10) after processing in step S1854, that processing branches to NO, and determination processing in step S1852 is further performed.

Agent 20 determines whether or not evaluation value EVV is smaller than reference value RV (step S1853). When evaluation value EVV is equal to or larger than reference value RV (NO in step S1853), agent 20 has the process proceed to step S1854. Thus, once bid BI is suspended, suspension of bid BI continues until evaluation value EVV becomes smaller than reference value RV.

When evaluation value EVV is smaller than reference value RV (YES in step S1853), agent 20 resets the number of times of penalty NPT to 0 (step S1855).

Then, agent 20 sets bid plan BP to put in bid BI (step S1859). When processing in step S1859 is performed after bid BI was suspended (YES in step S1852), bid BI is resumed. After processing in step S1859, the process proceeds to step S190 (FIG. 10).

As set forth above, agent 20 according to the first embodiment includes bid processing unit 256 and indicator value calculator 261. Bid processing unit 256 is configured to put in bid BI to transaction market server 3. Indicator value calculator 261 calculates indicator value PI that represents an extent of the penalty imposed on the user in penalty processing. When indicator value PI reaches threshold value TH, bid processing unit 256 suspends bid BI.

According to such a configuration, when indicator value PI has reached threshold value TH, bid BI may be withdrawn or a future bid may not be put in. Since a contract is thus not concluded, transaction of power reception/provision is not scheduled. Consequently, occurrence of nonfulfillment of transaction is avoided. Therefore, increase of the penalty while the user of electrically powered vehicle 5 is unaware thereof can be avoided.

In the first embodiment, the number of times of penalty NPT is employed as exemplary indicator value PI. Penalties repeated for a long period to such an extent that the number of times of penalty NPT exceeds the threshold number of times THN can thus be avoided. Therefore, since transaction tends to be conducted in the power transaction market in a stable manner, usability in the power transaction market can be improved.

### First Modification of First Embodiment

In the first embodiment, after agent 20 once suspends bid BI, it resumes bid BI when evaluation value EVV decreases to reference value RV (steps S1853, S1855, and S1859 in FIG. 11).

In this first modification, after agent 20 once suspends bid BI, it resumes bid BI a prescribed time period after suspension of bid BI. Imposition of the penalty and suspension of bid BI involved therewith may occur due to prediction inappropriately made by state predictor 254. On the other hand, when a prescribed time period elapses since suspension of bid BI, prediction may appropriately be made. Therefore, resumption of bid BI may not give rise to a problem. Therefore, in the present modification, while processing for determination as to resumption of a bid is simplified, bid BI can appropriately be resumed.

FIG. 12 is a flowchart showing in detail, processing (step S185 in FIG. 10) involved with imposition of the penalty in this first modification.

Referring to FIG. 12, this flowchart is different from the flowchart (FIG. 11) in the first embodiment in that processing in step S1853A is performed instead of processing in step S1853. The flowchart in FIG. 12 is otherwise basically the same as the flowchart in FIG. 11.

When the number of times of penalty NPT has reached the threshold number of times THN (YES in step S1851) and thereafter bid BI has been suspended (YES in step S1852), agent 20 determines whether or not a prescribed time period has elapsed since suspension of bid BI (step S1853A).

When the prescribed time period has not elapsed (NO in step S1853A), agent 20 sets bid plan BP to suspend bid BI (step S1854). Suspension of bid BI thus continues until the prescribed time period elapses.

When the prescribed time period has elapsed since suspension of bid BI, agent 20 resets the number of times of penalty NPT (step S1855). Then, agent 20 sets bid plan BP to put in (resume) bid BI (step S1859).

### Second Modification of First Embodiment

In this second modification, a cumulative charge of penalty charges is employed as exemplary indicator value PI, instead of the number of times of penalty NPT. Charging of the cumulative charge smaller than a threshold value (a threshold charge) to a user is thus permitted. On the other hand, charging of the cumulative charge equal to or higher than a threshold value (a threshold charge) to the user is avoided. Consequently, charging to the user of the cumulative charge high to such an extent as being unexpected by the user can be avoided. The cumulative charge may be a total of penalty charges charged to the user over a prescribed period (for example, one month). The cumulative charge may be reset as the prescribed period elapses.

Referring again to FIG. 8, in this second modification, indicator value calculator 261 calculates indicator value PI (in this example, a cumulative charge of penalty charges) based on penalty information PINF. The penalty charge is included in penalty information PINF. Each time penalty information receiver 260 receives penalty information PINF, indicator value calculator 261 adds the penalty charge included in penalty information PINF to the cumulative charge before reception of penalty information PINF (a previous value).

Suspension determination unit 262 determines whether or not the cumulative charge has reached the threshold charge. In this example, the threshold charge is set to a prescribed charge and determined as appropriate. When the cumulative charge reaches the threshold charge, suspension determination unit 262 outputs bid suspension request BSR1 to bid processing unit 256.

When bid plan setting unit 258 of bid processing unit 256 receives bid suspension request BSR1, it updates bid plan BP to suspend bid BI put in by bid putting-in/withdrawing unit 259.

FIG. 13 is a flowchart showing in detail, processing involved with imposition of the penalty (step S185 in FIG. 10) in the second modification.

Referring to FIG. 13, this flowchart is different from the flowchart (FIG. 11) in the first embodiment in that processing in steps S1850B and S1851B is performed instead of processing in steps S1850 and S1851. The flowchart in FIG. 13 is otherwise basically the same as the flowchart in FIG. 11.

Agent 20 calculates cumulative charge CC of the penalty charges based on penalty information PINF (step S1850B).

Then, agent 20 determines whether or not cumulative charge CC has reached a threshold charge THC (step S1851B). When cumulative charge CC has not reached threshold charge THC (NO in step S1851B), agent 20 sets bid plan BP to put in bid BI (step S1859). When cumulative charge CC has reached threshold charge THC (YES in step S1851B), agent 20 has the process proceed to step S1852.

### Third Modification of First Embodiment

Threshold value TH is set to a prescribed value in the first embodiment and the first and second modifications thereof described previously. In this third modification, threshold value TH is set to a value different for each unit period (a variable value). A time slot is mainly employed as an exemplary unit period below.

Agent 20 sets threshold value TH in accordance with a procedure below. Agent 20 has history stored, the history indicating whether or not a penalty has been imposed on the user for each time slot. Agent 20 estimates possibility of imposition of the penalty on the user for each time slot in accordance with the history. Agent 20 sets threshold value TH to be smaller in a time slot in which possibility of imposition of the penalty on the user is higher (a first time slot) than in a time slot in which possibility of imposition of the penalty on the user is lower (a second time slot). In this case, indicator value PI in the first time slot and indicator value PI in the second time slot are calculated separately from each other (which will be described later in detail).

Whether or not imposition of the penalty on the user is likely may be different depending on a time slot. For example, in a region where traffic congestion in a time slot in the morning for commuting is likely, electrically powered vehicle 5 may schedule transaction of power reception/provision in this time slot. Consider a case in which charging and discharging facility 6 to which electrically powered vehicle 5 is scheduled to be connected for power transaction is not a charging and discharging facility in a house of the user of electrically powered vehicle 5 (by way of example, a charging and discharging facility at a worksite of this user). In this case, electrically powered vehicle 5 may not be able to arrive at charging and discharging facility 6 by the scheduled time to start power reception/provision due to traffic congestion. Consequently, electrically powered vehicle 5 may not be able to conduct transaction of power reception/provision due to failure in connection to charging and discharging facility 6 in a time slot determined in the contract. Therefore, in this region, in the time slot in the morning for commuting, nonfulfillment of transaction is more likely than in a time slot different from this time slot. In other words, imposition of the penalty on the user is likely.

Therefore, when agent 20 sets threshold value TH as above, indicator value PI is more likely to reach threshold value TH in the first time slot than in the second time slot. Suspension of bid BI is thus more likely in the first time slot than in the second time slot.

For example, when nonfulfillment of transaction once occurs in the first time slot, agent 20 may immediately suspend bid BI (the threshold number of times THN = 1). Consequently, the total penalty charge charged to the user by the time of suspension of the bid can be reduced.

On the other hand, even when nonfulfillment of transaction occurs M times (for example, M = 3) in the second time slot, agent 20 does not immediately suspend bid BI (the threshold number of times THN > M). Consequently, opportunities for power transaction can be secured.

Though twenty-four hours corresponding to one day are categorized into a time slot for commuting and another time slot in the example above, this is by way of example. How the twenty-four hours are categorized into time slots is determined in advance as appropriate and not limited.

FIG. 14 is a functional block diagram of agent 20 and transaction market server 3 in this third modification. Referring to FIG. 14, this functional block diagram is different from the functional block diagram (FIG. 8) in the first embodiment in addition of a penalty history creation unit (a penalty history updating unit) 273, a penalty history storage 274, a possibility estimator 276, and a threshold value setting unit 278. Furthermore, this functional block diagram is different from the functional block diagram in the first embodiment in that indicator value calculator 261 calculates indicator value PI for each unit period and suspension determination unit 262 performs determination processing for each unit period. The functional block diagram in this third modification is otherwise basically the same as the functional block diagram in the first embodiment.

Penalty history storage 274 corresponds to a storage area in memory 22. Functions of penalty history creation unit 273, possibility estimator 276, and threshold value setting unit 278 are performed by execution of computation program 221 by processor 21 of agent 20.

Penalty history creation unit 273 creates (updates) a penalty history 275 in penalty history storage 274 based on penalty information PINF received by penalty information receiver 260. A time slot in which the penalty was imposed is included in penalty information PINF. Each time penalty information receiver 260 receives penalty information PINF, penalty history creation unit 273 has imposition of the penalty and the time slot in which the penalty is imposed stored in penalty history storage 274 in association with each other. Penalty history 275 is thus created (updated) as a history of combination of imposition of the penalty and the time slot in which the penalty was imposed.

Penalty history 275 shows for each time slot whether or not the penalty has been imposed on the user. Though a duration of the time slot is set, for example, to thirty minutes, it is not limited. Furthermore, penalty history 275 shows the number of times of actual imposition of the penalty on the user (in other words, a statistical probability) for each time slot.

Possibility estimator 276 estimates for each time slot possibility of imposition of the penalty on the user in accordance with penalty history 275. A result of estimation (possibility above) may be the same as the statistical probability above. Possibility estimator 276 estimates a time slot larger in number of times of actual imposition of the penalty as a time slot higher in possibility of imposition of the penalty than a time slot smaller in number of times thereof. Similarly, possibility estimator 276 estimates the time slot smaller in number of times of actual imposition of the penalty as the time slot lower in possibility of imposition of the penalty than the time slot larger in number of times thereof. Each time penalty history 275 is updated, a result of estimation by possibility estimator 276 is also updated. In other words, possibility estimator 276 is trained by update of penalty history 275.

Threshold value setting unit 278 sets threshold value TH in accordance with a result of estimation by possibility estimator 276. Specifically, threshold value setting unit 278 sets threshold value TH to be smaller in the time slot higher in possibility of imposition of the penalty on the user (first time slot) than in the time slot lower in possibility of imposition of the penalty on the user (second time slot). Set threshold value TH is used by suspension determination unit 262. Threshold value setting unit 278 sets, for example, threshold value TH to TH1 in the first time slot and sets threshold value TH to TH2 in the second time slot (in this example, TH1 < TH2). Either the threshold number of times THN or threshold charge THC may be set as threshold value TH.

Indicator value calculator 261 calculates indicator value PI for each time slot. For example, indicator value calculator 261 calculates PI1 which is indicator value PI in the first time slot and PI2 which is indicator value PI in the second time slot separately from each other. Indicator value PI (PI1 and PI2) may be reset when a prescribed period (for example, one week) elapses.

Suspension determination unit 262 determines whether or not PI1 has reached TH1 in the first time slot. When PI1 has reached TH1, suspension determination unit 262 outputs bid suspension request BSR1 to bid processing unit 256. Similarly, suspension determination unit 262 determines whether or not PI2 has reached TH2 in the second time slot. When PI2 has reached TH2, suspension determination unit 262 outputs bid suspension request BSR1 to bid processing unit 256. In this example, possibility of PI1 reaching TH1 is higher than possibility of PI2 reaching TH2. Therefore, suspension of bid BI is more likely in the first time slot than in the second time slot.

FIG. 15 is a diagram showing exemplary processing performed by agent 20 for setting threshold value TH. This flowchart is started when agent 20 receives penalty information PINF.

Referring to FIG. 15, agent 20 creates (updates) penalty history 275 based on penalty information PINF (step S305).

Then, agent 20 estimates for each time slot possibility of imposition of the penalty on the user in accordance with penalty history 275 (step S307).

Then, agent 20 sets threshold value TH to be smaller in the time slot higher in possibility of imposition of the penalty (first time slot) than in the time slot lower in possibility of imposition of the penalty (second time slot) (step S310).

Though the time slot is employed as an exemplary unit period in the description above, one day in a week may be set as the unit period. In this case, agent 20 has a history stored, the history indicating for each day of the week whether or not the penalty was imposed on the user. Agent 20 estimates for each day of the week possibility of imposition of the penalty on the user in accordance with the history above. Agent 20 sets threshold value TH to be smaller on a day of the week higher in possibility of imposition of the penalty on the user (a first day of the week) than on a day of the week lower in possibility of imposition of the penalty on the user (a second day of the week).

### Fourth Modification of First Embodiment

In this fourth modification, agent 20 performs notification processing for giving a notification to the user when bid BI is suspended. The user can thus notice stop of bid BI.

Furthermore, agent 20 performs processing for inquiring of the user whether or not to resume bid BI. Thereafter, when agent 20 receives a response indicating resumption of bid BI, it resumes bid BI. Thus, when bid BI is stopped, the bid can be resumed based on a user’s intention. Consequently, usability can be improved.

FIG. 16 is a functional block diagram of agent 20 and transaction market server 3 in this fourth modification. Referring to FIG. 16, this functional block diagram is different from the functional block diagram (FIG. 8) in the first embodiment in that agent 20 further includes a notification processing unit 271 and an inquiry result receiver 272. This functional block diagram is further different from the functional block diagram in the first embodiment in that a user terminal 400 is shown. The functional block diagram in this fourth modification is otherwise basically the same as the functional block diagram in the first embodiment.

A function of notification processing unit 271 is performed by execution of computation program 221 by processor 21 of agent 20 and operation of communication device 23 in accordance with a command from processor 21. A function of inquiry result receiver 272 is performed by communication device 23.

When indicator value PI has reached threshold value TH, suspension determination unit 262 outputs bid suspension request BSR1 to bid processing unit 256 and outputs a notification request NR directed to the user to notification processing unit 271.

When notification processing unit 271 receives notification request NR, it performs notification processing for giving a notification to the user. Specifically, notification processing unit 271 outputs a screen display request SDR to user terminal 400 to show a screen for notifying the user of stop of bid BI.

User terminal 400 includes a processor 402, a display 405, an input device 410, and a communication device 415. User terminal 400 is, for example, a smartphone, a tablet computer, or a wearable device.

When user terminal 400 (processor 402) receives screen display request SDR through communication device 415, it shows a screen for notification to the user on display 405. In this fourth modification, the screen includes a message for inquiring of a user whether or not to resume bid BI in addition to a message notifying the user of stop of bid BI. Input device 410 includes a button for receiving an instruction to resume bid BI and a button for receiving an instruction to continue suspension of bid BI. When the user responds to the inquiry with the use of input device 410, user terminal 400 transmits a result of the inquiry directed to the user to agent 20 through communication device 415. In this example, it is assumed that a response to the inquiry indicating resumption of bid BI is given. Specifically, it is assumed that the button for receiving the instruction to resume bid BI is operated.

Inquiry result receiver 272 receives a result of the inquiry (an instruction to resume bid BI) from user terminal 400. Then, inquiry result receiver 272 outputs a bid resumption request BRR2 to bid processing unit 256.

When bid processing unit 256 receives bid resumption request BRR2, it resumes bid BI. Specifically, bid plan setting unit 258 updates bid plan BP to resume bid BI. Bid putting-in/withdrawing unit 259 resumes (puts in) the bid in accordance with updated bid plan BP.

When bid resumption request BRR2 is not outputted, stop of bid BI continues until resumption determination unit 257 outputs bid resumption request BRR1. This case corresponds to a case where there is no response indicating resumption of bid BI from the user such as a case of operation onto the button for receiving the instruction to continue suspension of bid BI.

FIG. 17 is a flowchart showing in detail, processing involved with imposition of the penalty (step S185 in FIG. 10) in the fourth modification. Though the number of times of penalty NPT is employed as indicator value PI in this example, cumulative charge CC (FIG. 13) of the penalty charges may be employed.

Referring to FIG. 17, this flowchart is different from the flowchart (FIG. 11) in the first embodiment in that processing in steps S1850a, S1856, S1857, S1858a, and S1858b is added. In this fourth modification, a flag is set to 0 before start of processing in the flowchart in FIG. 17 (specifically, at the time of start of the processing in the flowchart in FIG. 10). The flag is set to 0 or 1. A method of setting the flag will be described later in detail. The flowchart in FIG. 17 is otherwise basically the same as the flowchart in FIG. 11.

After agent 20 calculates the number of times of penalty NPT (after processing in step S1850), the process branches depending on whether the flag has a value 0 or 1 (step S1850a). When the flag has the value 1, agent 20 has the process proceed to step S1859.

When the flag has the value 0, agent 20 has the process proceed to step S1851. Processing in steps S1851 to S1855 is similar to the processing in the flowchart in FIG. 11.

After agent 20 suspends bid BI (after processing in step S1854), it performs notification processing for giving a notification to the user (step S1856). Specifically, agent 20 outputs screen display request SDR to user terminal 400 to show the screen for notifying the user of stop of bid BI. This screen is thus shown on display 405 of user terminal 400. Thereafter, the user gives a response indicating continuation of suspension of bid BI or resumption of bid BI with the use of input device 410.

Agent 20 determines whether or not it has received the response indicating resumption of bid BI from the user (step S1857). When agent 20 does not receive this response (NO in step S1857), it sets the flag to 0 (step S1858a). In this case, the user may desire stop of bid BI until evaluation value EVV becomes smaller than reference value RV (until the process branches to YES in step S1853).

When agent 20 receives this response (YES in step S1857), it sets the flag to 1 (step S1858b). In this case, the user may desire resumption of bid BI regardless of evaluation value EVV. Therefore, after processing in step S1858b, bid BI is resumed (step S1859). In this example, after the flag is set to 1, bid BI continues regardless of evaluation value EVV (steps S1850a and S1859). Agent 20 may reset the flag to 0 after lapse of a prescribed period since setting of the flag to 1 (step S 1858b).

### Fifth Modification of First Embodiment

In this fifth modification, when nonfulfillment of transaction of power reception/provision occurs, agent 20 performs processing for lessening the penalty involved with nonfulfillment.

For example, consider a case in which electrically powered vehicle 5 has been scheduled to provide or receive electric power in a quantity of electric power determined in the contract to and from a transaction partner, however, it has been unable to do so (nonfulfillment occurs). In this case, agent 20 puts in a bid to transaction market server 3 for selling the right to power reception/provision to and from the transaction partner to a third party different from the transaction partner.

This bid is also referred to as a “counter bid” below. The counter bid is different from bid BI in being put in in response to nonfulfillment of transaction in the contract concluded for bid BI. The counter bid is put in by bid putting-in/withdrawing unit 259 (FIG. 8) of bid processing unit 256.

When a contract for the counter bid is concluded between the user of agent 20 and the third party, the transaction partner can provide or receive electric power in the quantity of electric power determined in the contract to and from the third party instead of electrically powered vehicle 5. Consequently, a detriment to the transaction partner caused by nonfulfillment of transaction by the user of electrically powered vehicle 5 (agent 20) is lessened. Therefore, in the power transaction market in this fifth modification, the penalty imposed on the user of agent 20 is lessened.

FIG. 18 is a flowchart showing processing involved with transaction of power reception/provision in a fifth modification. Referring to FIG. 18, this flowchart is different from the flowchart (FIG. 10) in the first embodiment in that processing in step S172 and processing in S2720 to S2728 are added. The flowchart in FIG. 18 is different from the flowchart in FIG. 10 in that processing in S2750 is performed instead of processing in step S275. The flowchart in FIG. 18 is otherwise basically the same as the flowchart in FIG. 10.

When agent 20 detects nonfulfillment of the contract (YES in step S 160), it puts in a counter bid (step S172) in addition to performing processing for notifying transaction market server 3 of occurrence of nonfulfillment (step S165). Specifically, agent 20 transmits a counter bid signal to transaction market server 3.

After transaction market server 3 receives a notification about occurrence of nonfulfillment (nonfulfillment information NFI) (YES in step S270), it determines whether or not it has received a counter bid signal within a prescribed time period (step S2720).

When transaction market server 3 has not received the counter bid signal (NO in step S2720), the process proceeds to step S2750.

When transaction market server 3 has received the counter bid signal (YES in step S2720), it performs contract processing in connection with the counter bid (step S2722).

Then, transaction market server 3 determines whether or not a contract for the counter bid has been concluded within a prescribed time period (step S2724). Specifically, transaction market server 3 determines whether or not there is a third party that provides or receives electric power to and from an original transaction partner of the user of agent 20 in the power transaction market.

When the contract for the counter bid has been concluded (YES in step S2724), transaction market server 3 reduces the penalty charge charged to the user of agent 20 (step S2726). Specifically, the transaction market server generates penalty information PINF to make the penalty charge smaller than when this contract is not concluded. Thereafter, the process proceeds to step S2750.

When the contract for the counter bid has not been concluded (NO in step S2724), transaction market server 3 notifies agent 20 of the contract for the counter bid being incomplete (step S2728). In this case, the penalty charge is the same as the charge when the counter bid is not put in (the charge in the case of FIG. 10). After step S2728, the process proceeds to step S2750.

In step S2750, transaction market server 3 performs penalty processing. The charge charged to the user of agent 20 is different depending on whether or not processing in step S2726 (processing for reducing the penalty charge) is performed.

When the contract for the counter bid has been concluded, the penalty charge per one nonfulfillment can be reduced. Even when the contract for the counter bid involved with present nonfulfillment of power transaction is not concluded, the contract may be concluded for a counter bid involved with next nonfulfillment of power transaction. The counter bid can thus contribute to reduction in expected value of the penalty charge per one nonfulfillment.

In an example where the number of times of penalty NPT is employed as indicator value PI, the expected value of cumulative charge CC of the penalty charges at a time point of suspension of bid BI (a time point when the number of times of penalty NPT reaches the threshold number of times THN) is reduced owing to the counter bid. In other words, the counter bid can contribute to reduction in cumulative charge CC charged to the user by the time of suspension of the bid.

Furthermore, for example, when the fourth modification described previously is combined with this fifth modification, the counter bid can contribute to reduction in cumulative charge CC at the time point when the user is notified of suspension of bid BI. In other words, cumulative charge CC which the user notices at the time when the user receives the notification can be reduced.

The counter bid is effective also when cumulative charge CC is employed as indicator value PI. As described previously, the counter bid can contribute to reduction in expected value of the penalty charge per one nonfulfillment. Therefore, time required before the time point of suspension of bid BI (the time point when indicator value PI reaches threshold charge THC) is extended owing to the counter bid. Consequently, more opportunities for power transaction can be secured than when the counter bid is not put in.

### Second Embodiment

In the first embodiment, it is assumed that agent 20 suspends bid BI when the penalty is actually imposed and indicator value PI reaches threshold value TH.

In a second embodiment, agent 20 further predicts occurrence of nonfulfillment. When agent 20 predicts occurrence of nonfulfillment, it suspends bid BI.

According to such a configuration, bid BI is suspended before nonfulfillment occurs. Occurrence of nonfulfillment is thus prevented. Consequently, the penalty imposed on the user can be prevented.

FIG. 19 is a functional block diagram of agent 20 and transaction market server 3 in this second embodiment. Referring to FIG. 19, this functional block diagram is different from the functional block diagram (FIG. 8) in the first embodiment in that agent 20 further includes a nonfulfillment predictor 270. The functional block diagram in this second embodiment is otherwise basically the same as the functional block diagram in the first embodiment.

A function of nonfulfillment predictor 270 is performed by execution of computation program 221 by processor 21 of agent 20 and operation of communication device 23 in accordance with a command from processor 23.

Nonfulfillment predictor 270 performs prediction processing for predicting occurrence of nonfulfillment during a period after conclusion of a contract and until scheduled time to start power reception/provision. More specifically, in this example, nonfulfillment predictor 270 performs the prediction processing in accordance with contract content information CCI, global positioning system (GPS) information, power facility position information, and current time.

The GPS information is obtained (received) by communication device 23 from an artificial satellite and indicates a current position of electrically powered vehicle 5. The power facility position information indicates a position of charging and discharging facility 6 to which electrically powered vehicle 5 is scheduled to be connected for transaction of power reception/provision. In this example, nonfulfillment predictor 270 obtains the power facility position information from transaction market server 3. This charging and discharging facility 6 may be a power facility highly likely to be connected to electrically powered vehicle 5 for transaction of power reception/provision such as a power facility provided at a prescribed location such as a garage of a house or a worksite of the user. In this case, the power facility position information may be stored in memory 22 of electrically powered vehicle 5.

Nonfulfillment predictor 270 determines whether or not electrically powered vehicle 5 is able to arrive at the position of charging and discharging facility 6 before the scheduled time to start power reception/provision based on contract content information CCI, the GPS information, the power facility position information, and the current time. When nonfulfillment predictor 270 determines that electrically powered vehicle 5 is unable to arrive at the position of charging and discharging facility 6 before the scheduled start time, it determines that power reception/provision is not carried out as in the contents in the contract. This case corresponds to a case where electrically powered vehicle 5 cannot be connected to charging and discharging facility 6 because the user of electrically powered vehicle 5 is “going out” to a location distant from home or the worksite. When nonfulfillment predictor 270 predicts occurrence of nonfulfillment, it outputs a bid suspension request BSR2 to bid processing unit 256.

When bid processing unit 256 receives bid suspension request BSR2, it suspends bid BI. More specifically, bid plan setting unit 258 of bid processing unit 256 sets (updates) bid plan BP to suspend bid BI put in by the bid putting-in/withdrawing unit.

When nonfulfillment predictor 270 determines that electrically powered vehicle 5 is able to arrive at the position of charging and discharging facility 6 before the scheduled start time, it does not output bid suspension request BSR2 to bid processing unit 256.

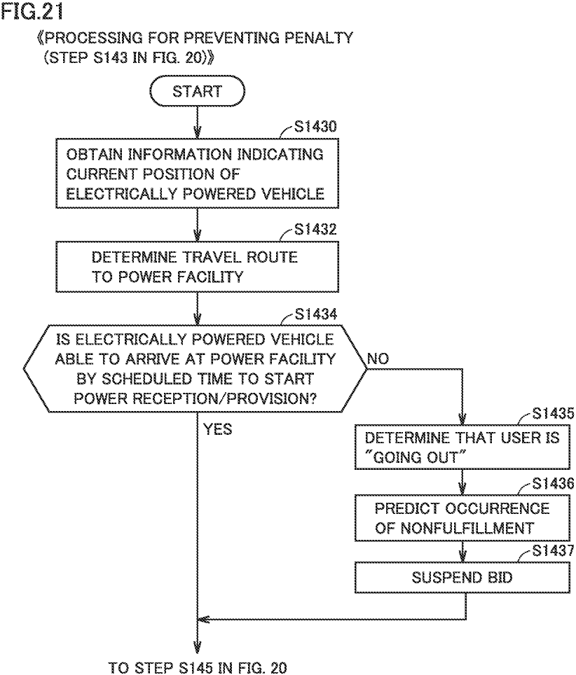

FIG. 20 is a flowchart showing processing involved with transaction of power reception/provision in the second embodiment. Referring to FIG. 20, this flowchart is different from the flowchart (FIG. 11) in the first embodiment in that processing in step S143 is performed. The flowchart in FIG. 20 is otherwise basically the same as the flowchart in FIG. 11.

When agent 20 receives contract content information CCI (YES in step S140), it performs processing for preventing the penalty (step S143). Details of this processing will be described below.

FIG. 21 is a diagram showing in detail, exemplary processing for preventing the penalty (step S143).

Referring to FIG. 21, agent 20 obtains information indicating the current position of electrically powered vehicle 5 based on the GPS information (step S1430).

Then, agent 20 determines a travel route to the power facility to which electrically powered vehicle 5 is scheduled to be connected for transaction of power reception/provision. Agent 20 determines the travel route from the current position to the power facility with the use of a known algorithm in accordance with the position of this power facility and the current position of electrically powered vehicle 5.

Then, agent 20 determines whether or not electrically powered vehicle 5 is able to arrive at the power facility by the scheduled time to start power reception/provision (step S1434). Specifically, agent 20 determines whether or not a time period for traveling required by electrically powered vehicle 5 to travel over the travel route (for example, at a prescribed speed) is shorter than a time period from the current time to the scheduled start time. This scheduled start time is determined in contract content information CCI.

When electrically powered vehicle 5 is able to arrive at the power facility by the scheduled time to start power reception/provision (YES in step S1434), agent 20 has the process proceed to step S145 (FIG. 20). A case in which the process branches to YES in step S1434 includes also a case where electrically powered vehicle 5 has not moved but has already been parked in immediate proximity to the power facility. In this case, by way of example, electrically powered vehicle 5 may have already been connected to charging and discharging facility 6 in a garage of the user’s house because the user of electrically powered vehicle 5 works from home. Processing in step S145 or later is similar to processing in the first embodiment and the first to fifth modifications thereof.

When electrically powered vehicle 5 is unable to arrive at the power facility by the scheduled time to start power reception/provision (NO in step S1434), agent 20 determines that the user is “going out” (step S1435) and predicts occurrence of nonfulfillment (step S1436). Then, agent 20 suspends bid BI (step S1437).

### Modification of Second Embodiment

Referring again to FIG. 19, agent 20 may be configured to output only bid suspension request BSR2, of bid suspension requests BSR1 and BSR2. In other words, agent 20 does not have to include suspension determination unit 262 that outputs bid suspension request BSR1.

### Other Modifications

Though nonfulfillment is detected over a period from the time to start power reception/provision to time to quit power reception/provision in the description above, it may be detected after this period. In the example in FIG. 10, steps S160 to S185 may be performed after processing in step S195. In this case, processing in steps S270 and 275 is performed after processing in step S297.

In the power transaction market, transaction rules may be determined not to permit withdrawing, of stop and withdrawing of bid BI. In such a market, when indicator value PI has reached threshold value TH or when occurrence of nonfulfillment is predicted before the scheduled time to start power reception/provision, agent 20 (bid processing unit 256) may carry out only stop of bid BI (bid NYBI in FIG. 9).

Though embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. An information processing apparatus that puts in a bid to allow a vehicle as an electric power resource to conduct transaction of power reception or provision through a power transaction market server, the power transaction market server being configured to perform contract processing for concluding a contract for the bid for transaction of the power reception or provision, the power transaction market server performing penalty processing for imposing a penalty on a user of the vehicle in event of nonfulfillment of the transaction which means the vehicle does not conduct transaction of the power reception or provision in accordance with contract content information indicating contents of the contract, the information processing apparatus comprising:
a bid processing unit configured to put in the bid to the power transaction market server; and
an indicator value calculator that calculates an indicator value that represents an extent of the penalty imposed on the user in the penalty processing, wherein
the bid processing unit suspends the bid when the indicator value reaches a threshold value.

2. The information processing apparatus according to claim 1, wherein
the indicator value includes the number of times of the penalty.

3. The information processing apparatus according to claim 1, wherein
the penalty includes a penalty charge charged to the user, and
the indicator value includes a cumulative charge of the penalty charge.

4. The information processing apparatus according to claim 1, comprising:
a state obtaining unit that obtains a vehicle state;
a state history storage in which history of the vehicle state is stored; and
a state predictor that predicts the vehicle state after current time in accordance with the history stored in the state history storage, wherein
the bid processing unit
puts in the bid in accordance with a result of prediction by the state predictor, and
resumes the bid when an evaluation value representing magnitude of a difference between a result of obtainment by the state obtaining unit and a result of prediction by the state predictor becomes smaller than a reference value after the bid is suspended.

5. The information processing apparatus according to claim 1, comprising:
a state obtaining unit that obtains a vehicle state;
a state history storage in which history of the vehicle state is stored; and
a state predictor that predicts the vehicle state after current time in accordance with the history stored in the state history storage, wherein
the bid processing unit
puts in the bid in accordance with a result of prediction by the state predictor, and
resumes the bid a prescribed time period after suspension of the bid.

6. The information processing apparatus according to claim 1, further comprising a notification processing unit configured to perform notification processing for giving a notification to the user when the bid is suspended.

7. The information processing apparatus according to claim 6, wherein
the notification processing includes processing for inquiring of the user whether to resume the bid, and
the bid processing unit resumes the bid when there is a response indicating resumption of the bid.

8. The information processing apparatus according to claim 1, further comprising:
a penalty history storage in which history showing for each unit period whether the penalty was imposed on the user is stored;
a possibility estimator that estimates for each unit period possibility of imposition of the penalty on the user in accordance with the history stored in the penalty history storage; and
a threshold value setting unit that sets the threshold value to be smaller during a first unit period during which possibility of imposition of the penalty on the user is higher than during a second unit period during which possibility of imposition of the penalty on the user is lower.

9. The information processing apparatus according to claim 1, further comprising a nonfulfillment predictor that predicts whether the nonfulfillment occurs, wherein
when the nonfulfillment predictor predicts occurrence of the nonfulfillment, the bid processing unit suspends the bid.

10. The information processing apparatus according to claim 9, wherein
the nonfulfillment predictor
determines whether the vehicle is able to arrive at a position of a power facility to which the vehicle is scheduled to be connected for transaction of the power reception or provision before scheduled time to start the power reception or provision in accordance with first position information indicating a current position of the vehicle, second position information indicating a position of the power facility, and current time, and
predicts occurrence of the nonfulfillment when the nonfulfillment predictor determines that the vehicle is unable to arrive at the position of the power facility before the scheduled time to start.

11. The information processing apparatus according to claim 1, wherein
when the nonfulfillment of the transaction occurs, the bid processing unit puts in a bid for selling a right to power reception or provision to and from a transaction partner of the vehicle in the transaction to the power transaction market server, and
this power is electric power in a quantity determined in the contract in connection with the transaction.

12. An information processing apparatus that puts in a bid to allow a vehicle as an electric power resource to conduct transaction of power reception or provision through a power transaction market server, the power transaction market server being configured to perform contract processing for concluding a contract for the bid for transaction of the power reception or provision, the power transaction market server performing penalty processing for imposing a penalty on a user of the vehicle in event of nonfulfillment of the transaction which means the vehicle does not conduct transaction of the power reception or provision in accordance with contract content information indicating contents of the contract, the information processing apparatus comprising:
a bid processing unit configured to put in the bid to the power transaction market server; and
a nonfulfillment predictor that predicts whether the nonfulfillment occurs, wherein
when the nonfulfillment predictor predicts occurrence of the nonfulfillment, the bid processing unit suspends the bid.
